(19) United States
(12) Patent Application Publication
(10) Pub. No.: US 2024/0154220 A1
(43) Pub. Date: May 9, 2024

(54) SECONDARY BATTERY

(71) Applicant: MURATA MANUFACTURING CO., LTD., Kyoto (JP)

(72) Inventor: Toshihiro SHIBAGAKI, Kyoto (JP)

(21) Appl. No.: 18/411,941

(22) Filed: Jan. 12, 2024

Related U.S. Application Data
(63) Continuation of application No. PCT/JP2022/025502, filed on Jun. 27, 2022.

(30) Foreign Application Priority Data
Jul. 20, 2021 (JP) 2021-120032

(51) Int. Cl. H01M 50/184; H01M 50/109; H01M 50/188; H01M 50/559

(52) U.S. Cl. CPC H01M 50/184; H01M 50/109; H01M 50/188; H01M 50/559

(57) ABSTRACT

A secondary battery is provided and includes an outer package member including a surface and a through hole, the through hole extending in a first direction and having an inner peripheral surface intersecting the surface; a battery device contained in the outer package member; an external terminal attached to the outer package member to close the through hole and electrically insulated from the outer package member, the external terminal including an opposed surface opposed to the surface of the outer package member in the first direction; and a sealing part present in a gap between the outer package member and the external terminal, the sealing part including a first part and a third part, the first part being located between the outer package member and the opposed surface of the external terminal and having a first thickness in the first direction, the third part being provided to be in contact with the inner peripheral surface of the outer package member and having a third thickness in the first direction, the third thickness being greater than the first thickness.

### CROSS REFERENCE TO RELATED APPLICATIONS

The present application is a continuation of PCT patent application no. PCT/JP2022/025502, filed on Jun. 27, 2022, which claims priority to Japanese patent application no. 2021-120032, filed on Jul. 20, 2021, the entire contents of which are incorporated herein by reference.

### BACKGROUND

The present application relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member. A configuration of the secondary battery has been considered in various ways.

For example, a sealed electrical storage device is disclosed in which an electrode body is contained in an outer casing. In the sealed electrical storage device, the outer casing has a casing body and a cover plate member, for example. The cover plate member is joined, by means of welding, to the casing body at an opening provided on a side opposite to a bottom part of the casing body. Further, a secondary battery is disclosed in which a battery cover is placed over and crimped to a battery can containing a wound electrode body. In addition, a cylindrical battery is disclosed having two positive electrode leads.

### SUMMARY

The present application relates to a secondary battery.

Consideration has been given in various ways to improve performance of a secondary battery, and there is a demand for further improvement in reliability.

It is therefore desirable to provide a secondary battery that makes it possible to achieve stable performance.

A secondary battery according to an embodiment of the present technology includes an outer package member, a battery device, an external terminal, and a sealing part. The outer package member includes a surface. The battery device is contained in the outer package member. The external terminal is attached to the outer package member and electrically insulated from the outer package member. The external terminal includes an opposed surface and an outer peripheral surface. The opposed surface is opposed to the surface of the outer package member in a first direction. The outer peripheral surface intersects the opposed surface. The sealing part is present in a gap between the outer package member and the external terminal, and includes a first part and a second part. The first part is located between the outer package member and the opposed surface of the external terminal, and has a first thickness in the first direction. The second part is provided to be in contact with the outer peripheral surface, and has a second thickness in the first direction. The second thickness is greater than the first thickness.

In the secondary battery according to the embodiment of the technology, the second thickness of the second part provided to be in contact with an outer peripheral surface of the external terminal is greater than the first thickness of the first part located between the outer package member and the opposed surface of the external terminal. This makes it possible for the secondary battery according to the embodiment of the technology to achieve stable performance.

Note that effects of the technology are not necessarily limited to those described herein and may include any suitable effect including as described below in relation to the present technology.

### BRIEF DESCRIPTION OF THE FIGURES

FIG. 1 is a perspective view of a configuration of a secondary battery according to an embodiment of the present technology.

FIG. 2 is a sectional view of the configuration of the secondary battery illustrated in FIG. 1.

FIG. 3 is a sectional view of a configuration of a battery device illustrated in FIG. 2.

FIG. 4 is a partial enlarged sectional diagram illustrating, in an enlarged manner, a gasket illustrated in FIG. 2 and a portion in the vicinity of the gasket.

FIG. 5 is a perspective view of a configuration of an outer package can to be used in a process of manufacturing the secondary battery.

FIG. 6 is a sectional view of the configuration of the outer package can illustrated to describe the process of manufacturing the secondary battery.

FIG. 7A is a first explanatory diagram for describing a process of thermally welding an external terminal to a cover part in the process of manufacturing the secondary battery illustrated in FIG. 1.

FIG. 7B is a second explanatory diagram for describing the process of thermally welding the external terminal to the cover part in the process of manufacturing the secondary battery illustrated in FIG. 1.

FIG. 8 is a sectional view of a configuration of a secondary battery according to an embodiment of the present technology.

FIG. 9A is a partial enlarged sectional diagram illustrating, in an enlarged manner, a gasket illustrated in FIG. 8 and a portion in the vicinity of the gasket.

FIG. 9B is an enlarged plan view of an external terminal illustrated in FIG. 8.

FIG. 10A is a first explanatory diagram for describing the process of thermally welding the external terminal to the cover part in the process of manufacturing the secondary battery illustrated in FIG. 8.

FIG. 10B is a second explanatory diagram for describing the process of thermally welding the external terminal to the cover part in the process of manufacturing the secondary battery illustrated in FIG. 8.

FIG. 11A is an enlarged sectional view of a first configuration example of a main part of a secondary battery of Modification 2.

FIG. 11B is an enlarged sectional view of a second configuration example of the main part of the secondary battery according to an embodiment.

FIG. 12A is an enlarged sectional view of a first configuration example of a main part of a secondary battery according to an embodiment.

FIG. 12B is an enlarged sectional view of a second configuration example of the main part of the secondary battery according to an embodiment.

FIG. 13 is a sectional view of a configuration of a secondary battery according to an embodiment.

FIG. 14 is a sectional view of a configuration of a secondary battery according to an embodiment.

FIG. 15 is an enlarged sectional view of a configuration of a main part of a secondary battery of Comparative example 1.

FIG. 16 is an enlarged sectional view of a configuration of a main part of a secondary battery of Comparative example 2.

### DETAILED DESCRIPTION

The present technology will be described below in further detail including with reference to the drawings according to an embodiment.

A description is given first of a secondary battery according to an embodiment of the present technology.

The secondary battery to be described here has a flat and columnar three-dimensional shape, and is commonly referred to as, for example, a coin type or a button type. As will be described later, the secondary battery includes two bottom parts opposed to each other, and a sidewall part located between the two bottom parts. This secondary battery has a height smaller than an outer diameter. The “outer diameter” is a diameter (a maximum diameter) of each of the two bottom parts. The “height” is a distance (a maximum distance) from a surface of one of the bottom parts to a surface of another of the bottom parts.

Although a charge and discharge principle of the secondary battery is not particularly limited, the following description deals with a case where a battery capacity is obtained using insertion and extraction of an electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case in which the electrode reactant is lithium. A secondary battery that obtains the battery capacity using insertion and extraction of lithium is what is called a lithium-ion secondary battery. In the lithium-ion secondary battery, lithium is inserted and extracted in an ionic state.

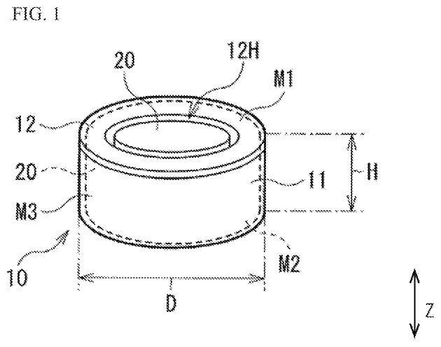

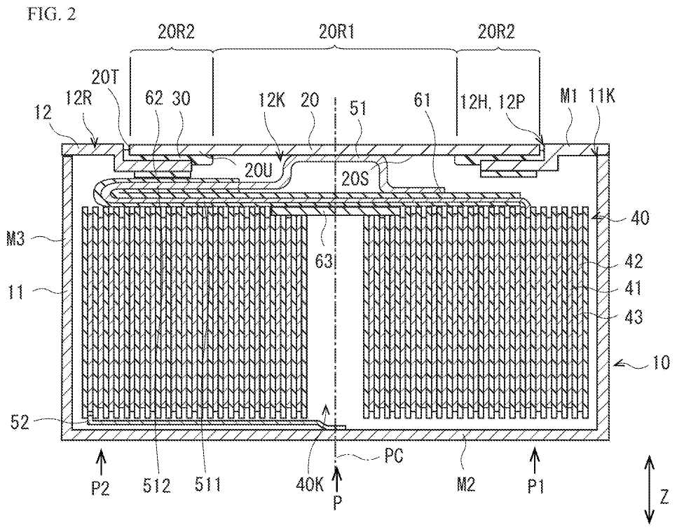

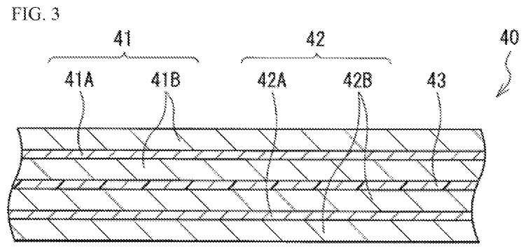

FIG. 1 illustrates a perspective configuration of the secondary battery. FIG. 2 illustrates a sectional configuration of the secondary battery illustrated in FIG. 1. FIG. 3 illustrates a sectional configuration of a battery device 40 illustrated in FIG. 2. Note that in FIG. 2, a positive electrode lead 51 is shaded, and FIG. 3 illustrates only a portion of the sectional configuration of the battery device 40 in an enlarged manner. Note that a Z-axis direction illustrated in FIGS. 1 and 2 is a height direction of the secondary battery according to the present embodiment.

For convenience, the following description is given with an upper side of each of FIGS. 1 and 2 assumed to be an upper side of the secondary battery, and a lower side of each of FIGS. 1 and 2 assumed to be a lower side of the secondary battery.

The secondary battery to be described here has a three-dimensional shape in which a height H is smaller than an outer diameter D, as illustrated in FIG. 1. In other words, the secondary battery has a flat and columnar three-dimensional shape. Here, the three-dimensional shape of the secondary battery is flat and cylindrical (circular columnar).

Dimensions of the secondary battery are not particularly limited. However, for example, the outer diameter D is within a range from 3 mm to 30 mm both inclusive, and the height H is within a range from 0.5 mm to 70 mm both inclusive. Note that a ratio of the outer diameter D to the height H, i.e., D/H, is greater than 1. Although not particularly limited, an upper limit of the ratio D/H is preferably less than or equal to 25.

As illustrated in FIGS. 1 to 3, the secondary battery includes an outer package can 10, an external terminal 20, the battery device 40, and the positive electrode lead 51. Here, the secondary battery further includes a gasket 30, a negative electrode lead 52, a sealant 61, and insulating films 62 and 63.

As illustrated in FIGS. 1 and 2, the outer package can 10 is a hollow outer package member to contain the battery device 40 and other components.

Here, the outer package can 10 has a flat and circular columnar three-dimensional shape corresponding to the three-dimensional shape of the secondary battery which is flat and circular columnar. Accordingly, the outer package can 10 includes two bottom parts M1 and M2 opposed to each other, and a sidewall part M3 located between the bottom parts M1 and M2. The sidewall part M3 has an upper end part coupled to the bottom part M1, and a lower end part coupled to the bottom part M2. As described above, the outer package can 10 is circular columnar. Thus, the bottom parts M1 and M2 are each circular in plan shape, and a surface of the sidewall part M3 is a convexly curved surface.

The outer package can 10 includes a container part 11 and a cover part 12 that are welded to each other. The container part 11 is sealed by the cover part 12. In other words, the cover part 12 is welded to the container part 11.

The container part 11 is a container member that is to contain the battery device 40 and other components inside, and has a flat and circular columnar shape. The container part 11 has a hollow structure with an upper end part open and a lower end part closed, and thus has an opening 11K at the upper end part.

The cover part 12 is a substantially disk-shaped cover member that closes the opening 11K of the container part 11, and has a through hole 12K. The through hole 12K is used as a coupling path for coupling the battery device 40 and the external terminal 20 to each other. As described above, the cover part 12 is welded to the container part 11 at the opening 11K. The external terminal 20 is attached to the cover part 12, and the cover part 12 thus supports the external terminal 20.

In the secondary battery having been completed, the opening 11K has been closed by the cover part 12 because the cover part 12 has already been welded to the container part 11 as described above. It may thus seem that whether the container part 11 has had the opening 11K is no longer recognizable from an external appearance of the secondary battery.

However, if the cover part 12 is welded to the container part 11, welding marks remain on a surface of the outer package can 10, more specifically, at a boundary part between the container part 11 and the cover part 12. Thus, whether the container part 11 has had the opening 11K is recognizable afterward by checking the presence or absence of the welding marks.

Specifically, the welding marks remaining on the surface of the outer package can 10 indicates that the container part 11 has had the opening 11K. In contrast, no welding marks remaining on the surface of the outer package can 10 indicates that the container part 11 has had no opening 11K.

Here, the cover part 12 is so bent as to partly protrude toward an inside of the container part 11 and thus forms a protruding part 12P. Specifically, as viewed from outside the outer package can 10, the cover part 12 has a partly recessed shape. Thus, as viewed from outside the outer package can 10, the protruding part 12P constitutes a recessed part 12H. The through hole 12K is provided in the protruding part 12P or the recessed part 12H. A portion of the cover part 12 other than the protruding part 12P is a peripheral part 12R. The peripheral part 12R is provided to surround the protruding part 12P and has an annular shape in a horizontal plane orthogonal to the height direction Z of the secondary battery.

A shape of the recessed part 12H in a plan view, that is, a shape defined by an outer edge of the recessed part 12H when the secondary battery is viewed from above, is not particularly limited. Here, the recessed part 12H has a substantially circular shape in a plan view. Note that an inner diameter and a depth of the recessed part 12H are each not particularly limited and may be set as desired.

As described above, the outer package can 10 is what is called a welded can in which the container part 11 and the cover part 12 that have been physically separate from each other are welded to each other. Thus, the outer package can 10 after the welding is a single member that is physically integral as a whole, and is in a state of being not separable into the container part 11 and the cover part 12 afterward.

The outer package can 10 that is a welded can is different from a crimped can formed by means of crimping processing, and is what is called a crimpless can. A reason for this is to increase a device space volume inside the outer package can 10 and to thereby increase an energy density per unit volume. The “device space volume” refers to a volume (an effective volume) of an internal space of the outer package can 10 available for containing the battery device 40.

Further, the outer package can 10 that is the welded can does not include any portion folded over another portion, and does not include any portion in which two or more members lie over each other.

The wording “does not include any portion folded over another portion” means that the outer package can 10 is not so processed (subjected to bending processing) as to include a portion folded over another portion. The wording “does not include any portion in which two or more members lie over each other” means that the outer package can 10 after completion of the secondary battery is physically a single member and is thus not separable into two or more members afterward. That is, the outer package can 10 in the secondary battery having been completed is not in a state where two or more members lie over each other and are so combined with each other as to be separable from each other afterward.

Here, the outer package can 10 is electrically conductive, and therefore the container part 11 and the cover part 12 are each electrically conductive. The outer package can 10 is thus electrically coupled to the battery device 40 (a negative electrode 42) via the negative electrode lead 52. Accordingly, the outer package can 10 serves as an external coupling terminal of the negative electrode 42. A reason for this is to make it unnecessary for the secondary battery to be provided with an external coupling terminal of the negative electrode 42 separate from the outer package can 10, and to thereby suppress a decrease in device space volume resulting from providing the external coupling terminal of the negative electrode 42. As a result, the device space volume increases, and the energy density per unit volume increases accordingly.

Specifically, the outer package can 10 includes any one or more of electrically conductive materials including, without limitation, a metal material and an alloy material. Examples of the electrically conductive material include iron, copper, nickel, stainless steel, an iron alloy, a copper alloy, and a nickel alloy. The stainless steel is not particularly limited in kind, and specific examples thereof include SUS304 and SUS316. Note that the container part 11 and the cover part 12 may include the same material or may include respective different materials.

As will be described later, the cover part 12 is insulated, via the gasket 30, from the external terminal 20 serving as an external coupling terminal of a positive electrode 21. A reason for this is to prevent a short circuit caused by contact between the outer package can 10, which is the external coupling terminal of the negative electrode 42, and the external terminal 20, which is the external coupling terminal of the positive electrode 41.

As illustrated in FIGS. 1 and 2, the external terminal 20 is a coupling terminal to be coupled to electronic equipment when the secondary battery is mounted on the electronic equipment. As described above, the external terminal 20 is attached to the outer package can 10 (the cover part 12), and is thus supported by the cover part 12. The external terminal 20 is so attached to the cover part 12 as to close the through hole 12K.

Here, the external terminal 20 is coupled to the positive electrode 41 of the battery device 40 via the positive electrode lead 51. The external terminal 20 thus serves as the external coupling terminal of the positive electrode 41. Accordingly, upon use of the secondary battery, the secondary battery is coupled to electronic equipment via the external terminal 20 (the external coupling terminal of the positive electrode 41) and the outer package can 10 (the external coupling terminal of the negative electrode 42). This allows the electronic equipment to operate with use of the secondary battery as a power source.

The external terminal 20 is a flat and substantially plate-shaped member, and is disposed inside the recessed part 12H with the gasket 30 interposed between the external terminal 20 and the recessed part 12H. The external terminal 20 is thus insulated from the cover part 12 via the gasket 30. Here, the external terminal 20 is so contained inside the recessed part 12H as not to protrude above the cover part 12. A reason for this is to reduce the height H of the secondary battery and to thereby increase the energy density per unit volume of the secondary battery, as compared with a case where the external terminal 20 protrudes above the cover part 12.

Note that the external terminal 20 has an outer diameter smaller than an inner diameter of the recessed part 12H. The external terminal 20 thus has an outer peripheral surface 20T spaced from the cover part 12. The gasket 30 is disposed in only a portion of a region between the external terminal 20 and the cover part 12 (the recessed part 12H). More specifically, the gasket 30 is disposed only at a location where the external terminal 20 and the cover part 12 would be in contact with each other if it were not for the gasket 30. In other words, the external terminal 20 is so attached to the outer package can 10 as to be electrically insulated from the outer package can 10, with the gasket 30 interposed between the external terminal 20 and the outer package can 10.

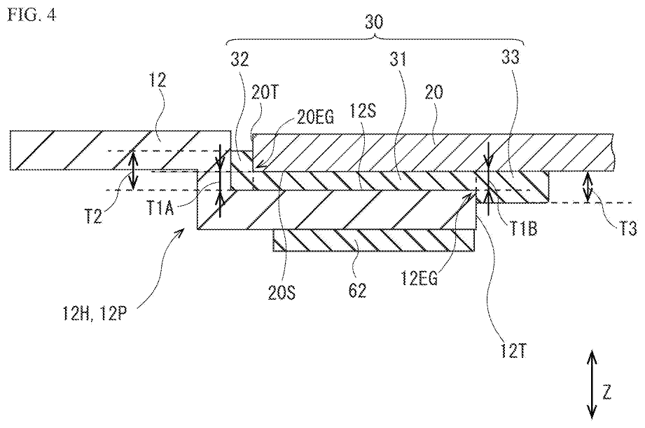

FIG. 4 is a partial enlarged sectional diagram illustrating, in an enlarged manner, a portion of the sectional configuration of the secondary battery illustrated in FIG. 2 where the external terminal 20 and the cover part 12 are opposed to each other. The external terminal 20 has an opposed surface 20S opposed to a surface 12S of the cover part 12 of the outer package can 10 in the Z-axis direction. Here, the surface 12S and the opposed surface 20S are flat surfaces orthogonal to the Z-axis direction. As illustrated in FIGS. 2 and 4, the opposed surface 20S of the external terminal 20 includes a coupling region 20R1 and a peripheral region 20R2. The coupling region 20R1 includes a coupling location to which the positive electrode lead 51 is to be coupled. The peripheral region 20R2 is a region of the opposed surface 20S located on an outer side relative to the coupling region 20R1. Here, the external terminal 20 is welded to the surface 12S of the cover part 12 in the peripheral region 20R2, with the gasket 30 interposed between the external terminal 20 and the cover part 12. Thus, a gap between the external terminal 20 and the cover part 12 is sealed by the gasket 30. Note that in the present embodiment, the external terminal 20 is a substantially disk-shaped member and has the outer peripheral surface 20T that is curved in a substantially circular shape in a plane orthogonal to the Z-axis direction. Further, in the present embodiment, the outer peripheral surface 20T is substantially orthogonal to the opposed surface 20S. The coupling region 20R1 is a region including a center position P of the opposed surface 20S, and has a substantially circular plan shape.

The external terminal 20 includes any one or more of electrically conductive materials including, without limitation, a metal material and an alloy material. Examples of the electrically conductive materials include aluminum and an aluminum alloy. Alternatively, the external terminal 20 may include a cladding material having a stacked structure including a first layer having a first modulus of rigidity and a second layer having a second modulus of rigidity higher than the first modulus of rigidity. More specifically, the cladding material to be included in the external terminal 20 includes the first layer and the second layer disposed in this order from a side closer to the gasket 30. The first layer includes aluminum as a main component. The second layer includes nickel as a main component. The first layer and the second layer are roll-bonded to each other.

The gasket 30 is an insulating resin disposed between the outer package can 10 (the cover part 12) and the external terminal 20, as illustrated in FIG. 2. The external terminal 20 is welded to the cover part 12 with the gasket 30 interposed between the external terminal 20 and the cover part 12. The gasket 30 is ring-shaped in a plan view and has a through hole at a location corresponding to the through hole 12K. The gasket 30 includes any one or more of insulating resin materials including, without limitation, a polymer compound having an insulating property. Examples of the insulating resin materials include polypropylene and polyethylene.

A range of placement of the gasket 30 may be chosen as desired. Here, the gasket 30 is disposed in a gap between the surface 12S, which is a top surface of the cover part 12, and the opposed surface 20S, which is a bottom surface of the external terminal 20, inside the recessed part 12H. The gasket 30 is provided to seal the gap between the external terminal 20 and the cover part 12.

The gasket 30 includes a first part 31, a second part 32, and a third part 33. The first part 31 is located between the surface 12S of the cover part 12 and the opposed surface 20S of the external terminal 20, and has thicknesses T1A and T1B in the Z-axis direction. The thickness T1A corresponds to a distance between an edge 20EG of the external terminal 20 and the surface 12S of the cover part 12 in the Z-axis direction. The edge 20EG is a portion where the opposed surface 20S and the outer peripheral surface 20T intersect. In other words, the thickness T1A is a spacing between the opposed surface 20S and the surface 12S in the Z-axis direction at a position in the opposed surface 20S closest to the outer peripheral surface 20T. The thickness T1B corresponds to a distance between an edge 12EG of the cover part 12 and the opposed surface 20S of the external terminal 20 in the Z-axis direction. The edge 12EG is a portion where the surface 12S and an inner peripheral surface 12T intersect. In other words, the thickness T1B is a spacing between the opposed surface 20S and the surface 12S in the Z-axis direction at a position in the opposed surface 20S closest to the inner peripheral surface 12T. The thickness T1A and the thickness T1B may be different from each other or equal to each other. The second part 32 is provided to be continuous with the first part 31 and in contact with the outer peripheral surface 20T, and has a thickness T2 in the Z-axis direction. The thickness T2 is greater than the thickness T1A. The through hole 12K has the inner peripheral surface 12T intersecting the surface 12S. The gasket 30 further includes the third part 33 that is provided to be in contact with the inner peripheral surface 12T and that has a thickness T3 in the Z-axis direction. The thickness T3 is greater than the thickness T1B. Note that in the present embodiment, the inner peripheral surface 12T is substantially orthogonal to the surface 12S.

The battery device 40 is a power generation device that causes charging and discharging reactions to proceed. As illustrated in FIGS. 2 and 3, the battery device 40 is contained inside the outer package can 10. The battery device 40 includes the positive electrode 41 and the negative electrode 42. Here, the battery device 40 further includes a separator 43 and an electrolytic solution. The electrolytic solution is a liquid electrolyte, and is not illustrated.

A center line PC illustrated in FIG. 2 is a line segment corresponding to a center of the battery device 40 in a direction along the outer diameter D of the secondary battery (the outer package can 10). More specifically, a position P of the center line PC corresponds to a position of the center of the battery device 40.

The battery device 40 is what is called a wound electrode body. More specifically, in the battery device 40, the positive electrode 41 and the negative electrode 42 are stacked on each other with the separator 43 interposed between the positive electrode 41 and the negative electrode 42. In addition, the stack of the positive electrode 41, the negative electrode 42, and the separator 43 is wound. The positive electrode 41 and the negative electrode 42 are wound, remaining in a state of being opposed to each other with the separator 43 interposed between the positive electrode 41 and the negative electrode 42. As a result, a winding center space 40K is present at the center of the battery device 40.

Here, the positive electrode 41, the negative electrode 42, and the separator 43 are so wound that the separator 43 is disposed in each of an outermost wind of the wound electrode body and an innermost wind of the wound electrode body. Respective numbers of winds of the positive electrode 41, the negative electrode 42, and the separator 43 are not particularly limited, and may be chosen as desired.

The battery device 40 has a three-dimensional shape similar to the three-dimensional shape of the outer package can 10. The battery device 40 thus has a flat and circular columnar three-dimensional shape. This helps to prevent what is called a dead space, more specifically, a gap between the outer package can 10 and the battery device 40, from easily resulting when the battery device 40 is placed inside the outer package can 10, as compared with a case where the battery device 40 has a three-dimensional shape different from the three-dimensional shape of the outer package can 10. This allows for efficient use of the internal space of the outer package can 10. As a result, the device space volume increases, and the energy density per unit volume of the secondary battery increases accordingly.

The positive electrode 41 is a first electrode to be used to cause the charging and discharging reactions to proceed. As illustrated in FIG. 3, the positive electrode 41 includes a positive electrode current collector 41A and a positive electrode active material layer 41B.

The positive electrode current collector 41A has two opposed surfaces on each of which the positive electrode active material layer 41B is to be provided. The positive electrode current collector 41A includes an electrically conductive material such as a metal material. Examples of the metal material include aluminum.

The positive electrode active material layer 41B is provided on each of the two opposed surfaces of the positive electrode current collector 41A. The positive electrode active material layer 41B includes any one or more of positive electrode active materials into which lithium is insertable and from which lithium is extractable. Note that the positive electrode active material layer 41B may be provided only on one of the two opposed surfaces of the positive electrode current collector 41A. The positive electrode active material layer 41B may further include other materials including, without limitation, a positive electrode binder and a positive electrode conductor. A method of forming the positive electrode active material layer 41B is not particularly limited, and specific examples thereof include a coating method.

The positive electrode active material includes a lithium compound. The term “lithium compound” is a generic term for a compound that includes lithium as a constituent element. More specifically, the lithium compound is a compound that includes lithium and one or more transition metal elements as constituent elements. A reason for this is that a high energy density is obtainable. Note that the lithium compound may further include any one or more of other elements (excluding lithium and transition metal elements). Although not particularly limited in kind, the lithium compound is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes any one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes any one or more of electrically conductive materials including, without limitation, a carbon material. Examples of the carbon material include graphite, carbon black, acetylene black, and Ketjen black. The electrically conductive material may be a metal material or a polymer compound, for example.

The negative electrode 42 is a second electrode to be used to cause the charging and discharging reactions to proceed. As illustrated in FIG. 3, the negative electrode 42 includes a negative electrode current collector 42A and a negative electrode active material layer 42B.

The negative electrode current collector 42A has two opposed surfaces on each of which the negative electrode active material layer 42B is to be provided. The negative electrode current collector 42A includes an electrically conductive material such as a metal material. Examples of the metal material include copper.

The negative electrode active material layer 42B is provided on each of the two opposed surfaces of the negative electrode current collector 42A. The negative electrode active material layer 42B includes any one or more of negative electrode active materials into which lithium is insertable and from which lithium is extractable. Note that the negative electrode active material layer 42B may be provided only on one of the two opposed surfaces of the negative electrode current collector 42A. The negative electrode active material layer 42B may further include other materials including, without limitation, a negative electrode binder and a negative electrode conductor. Details of the negative electrode binder are similar to the details of the positive electrode binder. Details of the negative electrode conductor are similar to the details of the positive electrode conductor. A method of forming the negative electrode active material layer 42B is not particularly limited, and specifically includes any one or more of methods including, without limitation, a coating method, a vapor-phase method, a liquid-phase method, a thermal spraying method, and a firing (sintering) method.

The negative electrode active material includes a carbon material, a metal-based material, or both. A reason for this is that a high energy density is obtainable. Examples of the carbon material include graphitizable carbon, non-graphitizable carbon, and graphite (natural graphite and artificial graphite). The metal-based material is a material that includes, as one or more constituent elements, any one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Here, the negative electrode 42 has a height greater than a height of the positive electrode 41. More specifically, the negative electrode 42 protrudes above the positive electrode 41, and protrudes below the positive electrode 41. A reason for this is to prevent precipitation of lithium extracted from the positive electrode 41. The “height” is a dimension corresponding to the height H of the secondary battery described above, that is, a dimension in an up-down direction or in the Z-axis direction in each of FIGS. 1 and 2. The definition of the height described here applies also to the following.

The separator 43 is an insulating porous film interposed between the positive electrode 41 and the negative electrode 42, as illustrated in FIGS. 2 and 3. The separator 43 allows lithium ions to pass through the separator 43 and prevents a short circuit between the positive electrode 41 and the negative electrode 42. The separator 43 includes a polymer compound such as polyethylene.

Here, the separator 43 has a height greater than the height of the negative electrode 42. More specifically, the separator 43 preferably protrudes above the negative electrode 42 and protrudes below the negative electrode 42. A reason for this is to insulate the positive electrode lead 51 from the negative electrode 42 by using the separator 43, as will be described later.

The electrolytic solution includes a solvent and an electrolyte salt. The positive electrode 41, the negative electrode 42, and the separator 43 are each impregnated with the electrolytic solution. The solvent includes any one or more of non-aqueous solvents (organic solvents) including, without limitation, a carbonic-acid-ester-based compound, a carboxylic-acid-ester-based compound, and a lactone-based compound. An electrolytic solution that includes any of the non-aqueous solvents is what is called a non-aqueous electrolytic solution. The electrolyte salt includes any one or more of light metal salts including, without limitation, a lithium salt.

As illustrated in FIG. 2, the positive electrode lead 51 is contained inside the outer package can 10. The positive electrode lead 51 is a coupling wiring line coupled to each of the positive electrode 41 and the external terminal 20. The secondary battery illustrated in FIG. 2 includes one positive electrode lead 51. Note that the secondary battery may include two or more positive electrode leads 51.

The positive electrode lead 51 is coupled to an upper end part of the positive electrode 41. Specifically, the positive electrode lead 51 is coupled to an upper end part of the positive electrode current collector 41A. Further, the positive electrode lead 51 is coupled to the coupling region 20R1 of the opposed surface 20S of the external terminal 20 through the through hole 12K provided in the cover part 12. A method of coupling the positive electrode lead 51 is not particularly limited, and specifically includes any one or more of welding methods including, without limitation, a resistance welding method and a laser welding method. The details of the welding methods described here apply also to the following.

A portion of the positive electrode lead 51 is electrically insulated from each of the cover part 12 of the outer package can 10 and the negative electrode 42 of the battery device 40, and is sandwiched by the cover part 12 and the battery device 40 in the height direction of the secondary battery. As illustrated in FIG. 4, the positive electrode lead 51 includes a first part 511, a second part 512, and a turning part 513. The first part 511 and the second part 512 each extend along a horizontal plane orthogonal to the height direction Z of the secondary battery. Further, the first part 511 and the second part 512 overlap each other in the height direction Z of the secondary battery, with the sealant 61 interposed between the first part 511 and the second part 512. The turning part 513 is so curved as to couple the first part 511 and the second part 512 to each other. The first part 511 and the second part 512 are sandwiched between the battery device 40 and the protruding part 12P of the cover part 12 in the height direction Z of the secondary battery.

In this way, the portion of the positive electrode lead 51 is held by the cover part 12 and the battery device 40 by extending along each of a bottom surface of the cover part 12 and a top surface of the battery device 40. This allows the positive electrode lead 51 to be fixed inside the outer package can 10. By preventing the positive electrode lead 51 from easily moving even if the secondary battery undergoes an external force such as vibration or impact, the positive electrode lead 51 is prevented from being easily damaged. Examples of damage to the positive electrode lead 51 include cracking of the positive electrode lead 51, breakage of the positive electrode lead 51, and detachment of the positive electrode lead 51 from the positive electrode 41.

More specifically, the wording “a portion of the positive electrode lead 51 is sandwiched by the outer package can 10 and the battery device 40” is intended to mean that the positive electrode lead 51 is held by the outer package can 10 and the battery device 40 from above and below while being insulated from each of the outer package can 10 and the battery device 40, and that the positive electrode lead 51 is thus in a state of being not easily movable inside the outer package can 10 even if the secondary battery undergoes an external force such as vibration or impact. The state where the positive electrode lead 51 is not easily movable inside the outer package can 10 exactly indicates that the battery device 40 is also in the state of being not easily movable inside the outer package can 10. This helps to prevent also the battery device 40, i.e., the wound electrode body, from suffering a defect such as winding deformation when the secondary battery undergoes vibration or impact.

Note that the positive electrode lead 51 preferably digs into the battery device 40 due to pressing by the battery device 40. More specifically, because the height of the separator 43 is greater than the height of each of the positive electrode 41 and the negative electrode 42 as described above, the positive electrode lead 51 preferably digs into an upper end part of the separator 43. In such a case, a recessed part is formed in the upper end part of the separator 43 due to pressing by the positive electrode lead 51. A portion or all of the positive electrode lead 51 is received in the recessed part, which allows the positive electrode lead 51 to be held by the separator 43. A reason for this is to further prevent the positive electrode lead 51 from easily moving inside the outer package can 10, and to thereby further prevent the positive electrode lead 51 from being easily damaged.

Here, as described above, the cover part 12 includes the protruding part 12P, and a portion of the positive electrode lead 51 is sandwiched by the protruding part 12P and the battery device 40. More specifically, the portion of the positive electrode lead 51 is held by the protruding part 12P and the battery device 40 by extending along each of the bottom surface of the protruding part 12P and the top surface of the battery device 40. The protruding part 12P helps to hold the positive electrode lead 51 more easily. This further prevents the positive electrode lead 51 from being easily damaged.

Further, the portion of the positive electrode lead 51 is insulated from the cover part 12 and the negative electrode 42 via each of the separator 43, the sealant 61, and the insulating films 62 and 63.

Specifically, as described above, the height of the separator 43 is greater than the height of the negative electrode 42. Accordingly, the portion of the positive electrode lead 51 is separated from the negative electrode 42 via the separator 43, and is thus insulated from the negative electrode 42 via the separator 43. A reason for this is to prevent a short circuit between the positive electrode lead 51 and the negative electrode 42.

Further, the positive electrode lead 51 is covered at a periphery thereof by the sealant 61 having an insulating property. The portion of the positive electrode lead 51 is thus insulated from each of the cover part 12 and the negative electrode 42 via the sealant 61. A reason for this is to prevent a short circuit between the positive electrode lead 51 and the cover part 12, and to also prevent a short circuit between the positive electrode lead 51 and the negative electrode 42.

Further, the insulating film 62 is disposed between the cover part 12 and the positive electrode lead 51. The portion of the positive electrode lead 51 is thus insulated from the cover part 12 via the insulating film 62. A reason for this is to prevent a short circuit between the positive electrode lead 51 and the cover part 12.

Furthermore, the insulating film 63 is disposed between the battery device 40 and the positive electrode lead 51. The portion of the positive electrode lead 51 is thus insulated from the negative electrode 42 via the insulating film 63. A reason for this is to prevent a short circuit between the positive electrode lead 51 and the negative electrode 42.

Details of a material included in the positive electrode lead 51 are similar to the details of the material included in the positive electrode current collector 41A. Note that the material included in the positive electrode lead 51 and the material included in the positive electrode current collector 41A may be the same or different from each other.

A position of coupling of the positive electrode lead 51 to the positive electrode 41 is not particularly limited, and may be chosen as desired. In particular, the positive electrode lead 51 is preferably coupled to the positive electrode 41 on an inner side of winding of the positive electrode 41 relative to an outermost wind of the positive electrode 41. A reason for this is that corrosion of the outer package can 10 caused by creeping up of the electrolytic solution is suppressed unlike when the positive electrode lead 51 is coupled to the positive electrode 41 in the outermost wind of the positive electrode 41. The “creeping up of the electrolytic solution” refers to a phenomenon in which, when the positive electrode lead 51 is disposed in proximity to an inner wall surface of the outer package can 10, the electrolytic solution in the battery device 40 creeps up along the positive electrode lead 51 to reach the inner wall surface of the outer package can 10. The electrolytic solution coming into contact with the outer package can 10 as a result of the “creeping up of the electrolytic solution” causes a phenomenon in which the outer package can 10 dissolves or changes in color.

Here, in a region between the positive electrode 41 and the external terminal 20, the positive electrode lead 51 is turned up once or more and thus lies over itself once or more. The number of times the positive electrode lead 51 is to be turned up is not particularly limited as long as it is once or more. The wording “the positive electrode lead 51 is turned up” means that the extending direction of the positive electrode lead 51 changes at an angle greater than 90° in the middle of the positive electrode lead 51.

The positive electrode lead 51 is turned up at the turning part 513 in the middle of extension from the positive electrode 41 to the external terminal 20. Specifically, as illustrated in FIG. 2, the first part 511 extends from a first position P1 to a second position P2 in a horizontal plane orthogonal to the height direction of the secondary battery. The first position P1 is other than the center position P of the outer package can 10. The second position P2 is on a side opposite to the first position P1 as viewed from the center position. The second part 512 extends from the second position P2 toward the center position P. In the positive electrode lead 51, an overlap portion of the first part 511 and the second part 512 is a surplus portion. It can thus be said that the positive electrode lead 51 has a length margin in a longitudinal direction of the positive electrode lead 51.

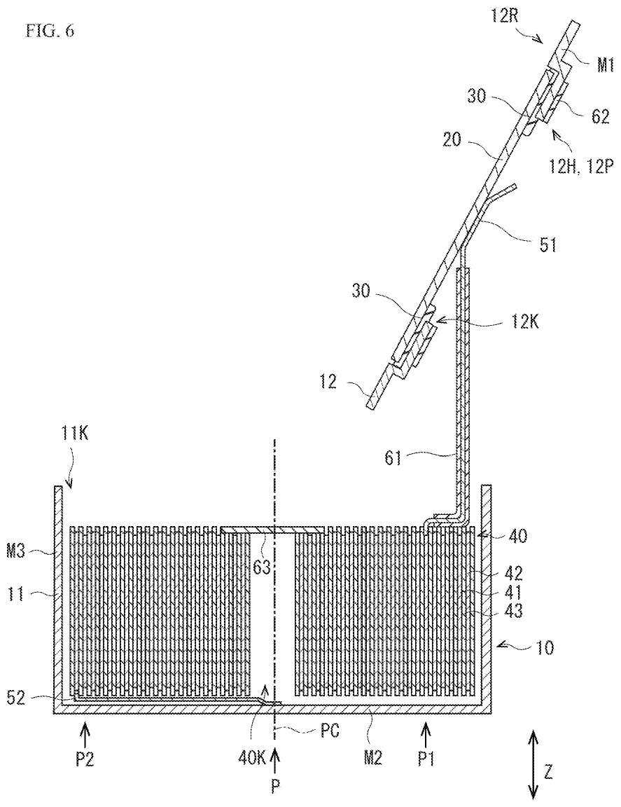

This provides room to change orientation of the cover part 12 relative to the container part 11 when forming the outer package can 10 by using the container part 11 and the cover part 12 in a process of manufacturing the secondary battery, as will be described later. Specifically, it becomes possible to raise the cover part 12 relative to the container part 11, as illustrated in FIG. 6 to be described later. Further, when the secondary battery undergoes an external force such as vibration or impact, the length margin of the positive electrode lead 51 is usable to mitigate the external force, thereby helping to prevent the positive electrode lead 51 from being easily damaged. Furthermore, the length margin of the positive electrode lead 51 is usable to change the position of coupling of the positive electrode lead 51 to the positive electrode 41 to a desired position without changing the positive electrode lead 51 in length.

In this case, the length (an entire length including the length margin) of the positive electrode lead 51 is not particularly limited, and may be chosen as desired. The length of the positive electrode lead 51 is preferably greater than or equal to half the outer diameter D of the outer package can 10, in particular. A reason for this is to ensure that the length of the positive electrode lead 51 has a length margin allowing for raising the cover part 12 relative to the container part 11, and to thereby make it easier to raise the cover part 12 relative to the container part 11.

A range of coupling of the positive electrode lead 51 to the external terminal 20 is not particularly limited. It is preferable that the range of coupling of the positive electrode lead 51 to the external terminal 20 be wide enough for the positive electrode lead 51 to be prevented from easily becoming detached from the external terminal 20 and be narrow enough to allow for the length margin of the positive electrode lead 51, in particular. A reason why the range of coupling of the positive electrode lead 51 to the external terminal 20 is preferably narrow enough is that a sufficiently large length margin of the positive electrode lead 51 is achievable because a portion of the positive electrode lead 51 not coupled to the external terminal 20 serves as the length margin.

Note that the positive electrode lead 51 is provided separately from the positive electrode current collector 41A. However, the positive electrode lead 51 may be physically continuous with the positive electrode current collector 41A and may thus be provided integrally with the positive electrode current collector 41A.

As illustrated in FIG. 2, the negative electrode lead 52 is contained inside the outer package can 10. The negative electrode lead 52 is coupled to each of the negative electrode 42 and the outer package can 10 (the container part 11). Here, the secondary battery includes one negative electrode lead 52. However, the secondary battery may include two or more negative electrode leads 52.

The negative electrode lead 52 is coupled to a lower end part of the negative electrode 42, more specifically, a lower end part of the negative electrode current collector 42A. Further, the negative electrode lead 52 is coupled to a bottom surface of the container part 11. Details of a method of coupling the negative electrode lead 52 are similar to the details of the method of coupling the positive electrode lead 51.

Details of a material included in the negative electrode lead 52 are similar to the details of the material included in the negative electrode current collector 42A. Note that the material included in the negative electrode lead 52 and the material included in the negative electrode current collector 42A may be the same or different from each other.

A position of coupling of the negative electrode lead 52 to the negative electrode 42 is not particularly limited, and may be chosen as desired. Here, the negative electrode lead 52 is coupled to an outermost wind portion of the negative electrode 42 included in the wound electrode body.

Note that the negative electrode lead 52 is provided separately from the negative electrode current collector 42A. However, the negative electrode lead 52 may be physically continuous with the negative electrode current collector 42A and may thus be provided integrally with the negative electrode current collector 42A.

The sealant 61 is a first insulating member covering the periphery of the positive electrode lead 51, as illustrated in FIG. 2. The sealant 61 has a tube-shaped structure. Here, to allow the positive electrode lead 51 to be coupled to each of the positive electrode 41 and the external terminal 20, the sealant 61 covers the periphery of a portion in the middle of the positive electrode lead 51.

The sealant 61 includes any one or more of insulating materials including, without limitation, a polymer compound having an insulating property. Examples of the insulating materials include polyimide.

The insulating film 62 is a second insulating member disposed between the cover part 12 and the positive electrode lead 51, as illustrated in FIG. 2. Here, the insulating film 62 is ring-shaped in a plan view and has a through hole at a location corresponding to the through hole 12K.

Here, the insulating film 62 may have an unillustrated adhesive layer on one surface, and may thus be adhered to either the cover part 12 or the positive electrode lead 51 via the adhesive layer. Alternatively, the insulating film 62 may have respective adhesive layers on both surfaces, and may thus be adhered to both the cover part 12 and the positive electrode lead 51 via the respective adhesive layers.

The insulating film 62 may include any one or more of insulating materials including, without limitation, a polymer compound having an insulating property. Examples of the insulating materials to be included in the insulating film 62 include polyimide.

The insulating film 63 is a third insulating member disposed between the battery device 40 and the positive electrode lead 51, as illustrated in FIG. 2. Here, the insulating film 63 is flat plate-shaped in a plan view. The insulating film 63 is disposed to block the winding center space 40K and to cover the battery device 40 around the winding center space 40K.

Details of a material included in the insulating film 63 are similar to the details of the material included in the insulating film 62. Note that the material included in the insulating film 63 and the material included in the insulating film 62 may be the same or different from each other.

Note that the secondary battery may further include one or more other components.

Specifically, the secondary battery includes a safety valve mechanism. The safety valve mechanism is to cut off electrical coupling between the outer package can 10 and the battery device 40 if an internal pressure of the outer package can 10 reaches a certain level or higher. Examples of a factor that causes the internal pressure of the outer package can 10 to reach the certain level or higher include the occurrence of a short circuit in the secondary battery and heating of the secondary battery from outside. Although a placement location of the safety valve mechanism is not particularly limited, the safety valve mechanism is preferably placed on either the bottom part M1 or the bottom part M2, and more preferably, on the bottom part M2 to which no external terminal 20 is attached, in particular.

Further, the secondary battery may include an insulator between the outer package can 10 and the battery device 40. The insulator includes any one or more of materials including, without limitation, an insulating film and an insulating sheet, and prevents a short circuit between the outer package can 10 and the battery device 40. A range of placement of the insulator is not particularly limited, and may be chosen as desired.

Note that the outer package can 10 is provided with a cleavage valve. The cleavage valve cleaves to release the internal pressure of the outer package can 10 when the internal pressure reaches a certain level or higher. A placement location of the cleavage valve is not particularly limited. However, the cleavage valve is preferably placed on either the bottom part M1 or the bottom part M2, and more preferably, on the bottom part M2, in particular, as with the placement location of the safety valve mechanism described above.

Upon charging of the secondary battery, in the battery device 40, lithium is extracted from the positive electrode 41, and the extracted lithium is inserted into the negative electrode 42 via the electrolytic solution. Upon discharging of the secondary battery, in the battery device 40, lithium is extracted from the negative electrode 42, and the extracted lithium is inserted into the positive electrode 41 via the electrolytic solution. Upon the charging and the discharging, lithium is inserted and extracted in an ionic state.

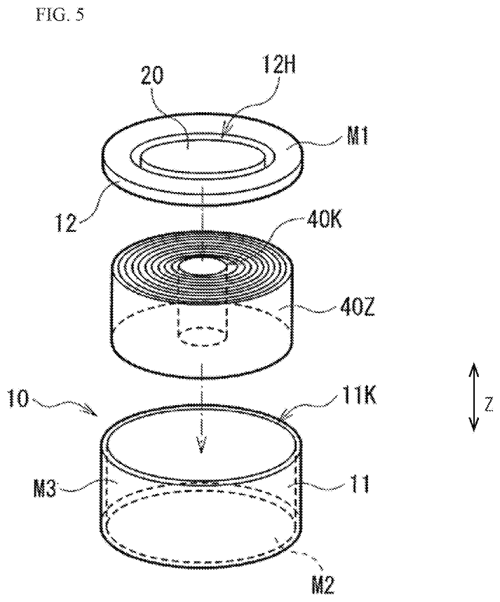

FIG. 5 illustrates a perspective configuration of the outer package can 10 to be used in the process of manufacturing the secondary battery, and corresponds to FIG. 1. FIG. 6 illustrates a sectional configuration of the outer package can 10 for describing the process of manufacturing the secondary battery, and corresponds to FIG. 2.

FIG. 5 illustrates a state where the cover part 12 is separate from the container part 11 before the cover part 12 is welded to the container part 11. FIG. 5 illustrates a state where the cover part 12 is not yet welded to the container part 11 and is raised relative to the container part 11.

In the following description, where appropriate, FIGS. 1 to 4 described already will be referred to in conjunction with FIGS. 5 and 6.

Here, as illustrated in FIG. 5, the container part 11 and the cover part 12 that are physically separate from each other are prepared to form the outer package can 10. The container part 11 is a substantially bowl-shaped member in which the bottom part M2 and the sidewall part M3 are integrated with each other, and has the opening 11K. The cover part 12 is a substantially plate-shaped member corresponding to the bottom part M1. The external terminal 20 is attached in advance to the recessed part 12H provided in the cover part 12, with the gasket 30 interposed between the external terminal 20 and the recessed part 12H.

Alternatively, the bottom part M2 and the sidewall part M3 that are physically separate from each other may be prepared and the container part 11 may be formed by welding the sidewall part M3 to the bottom part M2.

First, the positive electrode active material and other materials including, without limitation, the positive electrode binder and the positive electrode conductor are mixed with each other to thereby produce a positive electrode mixture. Thereafter, the positive electrode mixture thus produced is put into a solvent such as an organic solvent to thereby prepare a positive electrode mixture slurry in paste form. Thereafter, the positive electrode mixture slurry is applied on the two opposed surfaces of the positive electrode current collector 41A to thereby form the positive electrode active material layers 41B. Lastly, the positive electrode active material layers 41B are compression-molded by means of, for example, a roll pressing machine. In this case, the positive electrode active material layers 41B may be heated. The positive electrode active material layers 41B may be compression-molded multiple times. In this manner, the positive electrode 41 is fabricated.

The negative electrode 42 is fabricated by a procedure similar to the fabrication procedure of the positive electrode 41. Specifically, a negative electrode mixture, which is obtained by mixing the negative electrode active material and other materials including, without limitation, the negative electrode binder and the negative electrode conductor with each other, is put into an organic solvent to thereby prepare a negative electrode mixture slurry in paste form, following which the negative electrode mixture slurry is applied on the two opposed surfaces of the negative electrode current collector 42A to thereby form the negative electrode active material layers 42B. Thereafter, the negative electrode active material layers 42B are compression-molded by means of, for example, a roll pressing machine. In this manner, the negative electrode 42 is fabricated.

The electrolyte salt is put into the solvent. The electrolyte salt is thereby dispersed or dissolved in the solvent. Thus, the electrolytic solution is prepared.

First, by means of a welding method such as a resistance welding method, the positive electrode lead 51 covered at the periphery thereof by the sealant 61 is coupled to the positive electrode 41 (the positive electrode current collector 41A), and the negative electrode lead 52 is coupled to the negative electrode 42 (the negative electrode current collector 42A).

Thereafter, the positive electrode 41 and the negative electrode 42 are stacked on each other with the separator 43 interposed between the positive electrode 41 and the negative electrode 42, following which the stack including the positive electrode 41, the negative electrode 42, and the separator 43 is wound to thereby fabricate a wound body 40Z, as illustrated in FIG. 5. The wound body 40Z has a configuration similar to the configuration of the battery device 40 except that the positive electrode 41, the negative electrode 42, and the separator 43 are each unimpregnated with the electrolytic solution. Note that FIG. 5 omits the illustration of each of the positive electrode lead 51 and the negative electrode lead 52.

Thereafter, the wound body 40Z to which the positive electrode lead 51 and the negative electrode lead 52 are each coupled is placed into the container part 11 through the opening 11K. In this case, the negative electrode lead 52 is coupled to the container part 11 by means of a welding method such as a resistance welding method. Thereafter, the insulating film 63 is placed on the wound body 40Z.

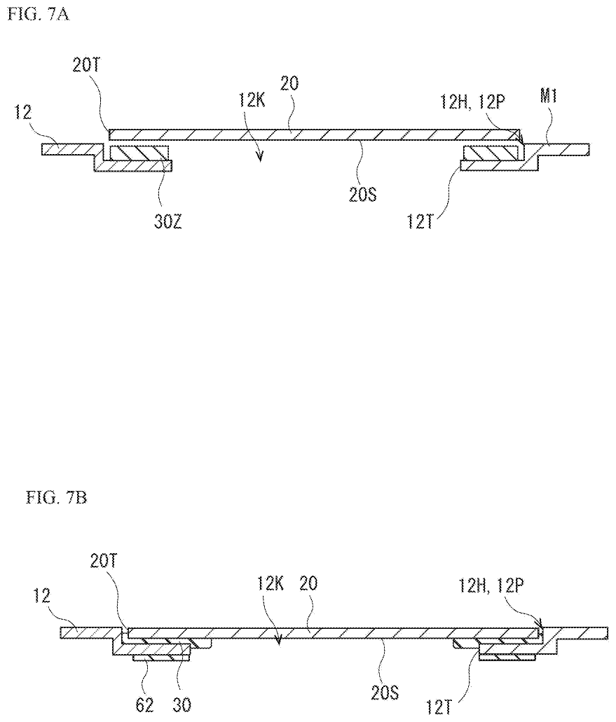

Thereafter, as illustrated in FIG. 7A, for example, an insulating resin 30Z is applied on the surface 12S of the cover part 12, following which the external terminal 20 is further placed on the insulating resin 30Z. Thereafter, as illustrated in FIG. 7B, while the insulating resin 30Z is heated and thereby melted, pressure is applied downward to the external terminal 20 to depress the external terminal 20. As a result, the insulating resin 30Z spreads from the opposed surface 20S to come into contact with also a portion of the outer peripheral surface 20T and a portion of the inner peripheral surface 12T. By cooling the insulating resin 30Z in this state, the insulating resin 30Z becomes the gasket 30, which causes the external terminal 20 to be welded to the cover part 12 with the gasket 30 interposed between the external terminal 20 and the cover part 12. Further, the insulating film 62 is attached to the bottom surface of the cover part 12. Thereafter, by means of a welding method such as a resistance welding method, the positive electrode lead 51 is coupled to the coupling region 20R1 of the external terminal 20 through the through hole 12K. Note that each of FIGS. 7A and 7B is an explanatory diagram for describing the process of thermally welding the external terminal 20 to the cover part 12 in the process of manufacturing the secondary battery illustrated in FIG. 1.

As a result, the wound body 40Z (the positive electrode 41) contained inside the container part 11 and the external terminal 20 attached to the cover part 12 are coupled to each other via the positive electrode lead 51. It thus becomes possible to raise the cover part 12 relative to the container part 11, as illustrated in FIG. 5, in a state where the wound body 40Z and the external terminal 20 are coupled to each other via the positive electrode lead 51.

As is apparent from FIG. 6, what is meant by “raise the cover part 12 relative to the container part 11” is to so dispose the cover part 12 as to be substantially orthogonal to the bottom surface of the container part 11, in order to prevent the cover part 12 from closing the opening 11K, while keeping a state where the battery device 40 and the external terminal 20 are coupled to each other via the positive electrode lead 51. In this case, by making the length of the positive electrode lead 51 sufficiently large, the positive electrode lead 51 is prevented from being under excessive tension or becoming twisted even upon raising the cover part 12 relative to the container part 11.

Thereafter, the electrolytic solution is injected into the container part 11 through the opening 11K. In this case, because the opening 11K is not closed by the cover part 12 as described above, the electrolytic solution is easily injectable into the container part 11 through the opening 11K even if the battery device 40 and the external terminal 20 are coupled to each other via the positive electrode lead 51. The wound body 40Z including the positive electrode 41, the negative electrode 42, and the separator 43 is thereby impregnated with the electrolytic solution. Thus, the battery device 40, i.e., the wound electrode body, is fabricated.

Thereafter, the cover part 12 is brought down into close proximity to the container part 11 to thereby close the opening 11K with the cover part 12, following which the cover part 12 is welded to the container part 11 by means of a welding method such as a laser welding method. In this case, as illustrated in FIG. 2, a portion of the positive electrode lead 51 is caused to be sandwiched between the cover part 12 and the battery device 40, and the turning part 513 that is curved is formed on a front side relative to the location where the positive electrode lead 51 is coupled to the external terminal 20. In this manner, the outer package can 10 is formed, and the battery device 40 and other components are contained inside the outer package can 10. Assembly of the secondary battery is thus completed.

The secondary battery after being assembled is charged and discharged. Various conditions including, for example, an environment temperature, the number of times of charging and discharging (the number of cycles), and charging and discharging conditions, may be chosen as desired. As a result, a film is formed on a surface of, for example, the negative electrode 42. This brings the secondary battery into an electrochemically stable state. The secondary battery is thus completed.

As described above, according to the secondary battery of the present embodiment, the gasket 30 serving as a sealing part to seal the gap between the cover part 12 of the outer package can 10 and the external terminal 20 includes the first part 31, the second part 32, and the third part 33. Here, the thickness T2 of the second part 32 in contact with the outer peripheral surface 20T of the external terminal 20 is greater than the thickness T1A of the first part 31 provided in the gap between the surface 12S and the opposed surface 20S. Further, the thickness T3 of the third part 33 in contact with the inner peripheral surface 12T is greater than the thickness T1B of the first part 31. The secondary battery of the present embodiment having such a configuration makes it possible to enhance airtightness inside the outer package can 10, as compared with when the gasket 30 includes neither the second part 32 nor the third part 33. Accordingly, the secondary battery is expected to provide effects including, without limitation, an effect of suppressing volatilization of, for example, the electrolytic solution included in the battery device 40 contained in the outer package can 10, and an effect of retarding deterioration of the battery device 40. It is thus possible to provide a secondary battery that is able to exhibit stable performance, such as a stable charge and discharge cyclability characteristic, over a long period of time.

Further, in the secondary battery according to the present embodiment, the cover part 12 is provided with the recessed part 12H, and the external terminal 20 is disposed in the recessed part 12H. This makes it possible to reduce a height dimension of the secondary battery while ensuring a battery capacity.

Further, in the secondary battery according to the present embodiment, the turning part 513 is located at a position corresponding to the peripheral portion 12R in the Z-axis direction of the cover part 12, and the first part 511 and the second part 512 extend in a radial direction of the secondary battery from the center position of the secondary battery toward the peripheral part 12R. Specifically, the first part 511 extends from the first position P1 to the second position P2 in a horizontal plane orthogonal to the height direction Z of the secondary battery. The first position P1 is other than the center position P of the outer package can 10, and the second position P2 is on the side opposite to the first position P1 as viewed from the center position P. The second part 512 extends from the second position P2 toward the center position. The overlap portion of the first part 511 and the second part 512 is sandwiched and held by the protruding part 12P and the battery device 40. This helps to ensure that the first part 511 is in contact with the battery device 40 over a larger area with the sealant 61 interposed between the first part 511 and the battery device 40, and that the second part 512 is in contact with the protruding part 12P over a larger area directly or with the sealant 61 interposed between the second part 512 and the protruding part 12P. Accordingly, movements of the positive electrode lead 51 and the battery device 40 inside the outer package can 10 are sufficiently limited. This helps to prevent a defect, such as damage to the positive electrode lead 51 or winding deformation of the battery device 40, from easily occurring even when the secondary battery undergoes impact or vibration. The secondary battery according to the present embodiment thus makes it possible to achieve superior physical durability.

In particular, the above-described action and effects are achievable by the secondary battery according to the present embodiment for reasons described below.

The secondary battery according to the present embodiment, which is referred to as, for example, the coin type or the button type, that is, the secondary battery having a flat and columnar three-dimensional shape, includes the external terminal 20 that is small in size and serves as the external coupling terminal of the positive electrode 41, as is apparent from FIGS. 1 and 2. In this case, the external terminal 20 having the small size results in a small coupling area of the positive electrode lead 51 to the external terminal 20. Accordingly, it is necessary to sufficiently fix the positive electrode lead 51 inside the outer package can 10 in order to maintain the state where the external terminal 20 and the positive electrode lead 51 are electrically coupled to each other.

In this regard, in the secondary battery according to the present embodiment, movement of the positive electrode lead 51 inside the outer package can 10 is sufficiently suppressed. Accordingly, even if the coupling area of the positive electrode lead 51 to the external terminal 20 is small, it is highly unlikely that the positive electrode lead 51 will become detached from the external terminal 20 or be broken. The secondary battery according to the present embodiment thus makes it possible to favorably maintain the state where the external terminal 20 and the positive electrode lead 51 are electrically coupled to each other even when the secondary battery undergoes an external force such as vibration or impact. It is therefore possible, with the secondary battery according to the present embodiment, to achieve high physical durability even if the secondary battery is reduced in size.

Further, in the secondary battery according to the present embodiment including the small-sized external terminal 20 serving as the external coupling terminal of the positive electrode 41, the cover part 12 of the outer package can 10 serving as the external coupling terminal of the negative electrode 42 is disposed in proximity to the external terminal 20, as is apparent from FIG. 2. In other words, the cover part 12 and the external terminal 20 which are two external coupling terminals having respective polarities different from each other are located close to each other. Accordingly, to prevent a short circuit between the cover part 12 and the external terminal 20, it is desirable that the coupling area of the positive electrode lead 51 to the external terminal 20 be sufficiently made small and that the positive electrode lead 51 be located sufficiently away from the cover part 12.

In this regard, in the secondary battery according to the present embodiment, movement of the positive electrode lead 51 inside the outer package can 10 is sufficiently suppressed. Accordingly, even if the coupling area of the positive electrode lead 51 to the external terminal 20 is small, it is highly unlikely that the positive electrode lead 51 will become detached from the external terminal 20 or be broken. The secondary battery according to the present embodiment thus makes it possible to favorably maintain the state where the external terminal 20 and the positive electrode lead 51 are electrically coupled to each other even when the secondary battery undergoes an external force such as vibration or impact. It is therefore possible, with the secondary battery according to the present embodiment, to achieve high physical durability while preventing a short circuit between the cover part 12 and the external terminal 20, even if the secondary battery is reduced in size.

Further, the height of the separator 43 having an insulating property may be greater than the height of the negative electrode 42, and a portion of the positive electrode lead 51 may be insulated from the negative electrode 42 via the separator 43. In such a case, a short circuit between the positive electrode lead 51 and the negative electrode 42 is prevented, and accordingly, it is possible to achieve higher reliability.

In this case, the positive electrode 41 and the negative electrode 42 may be wound, being opposed to each other with the separator 43 interposed between the positive electrode 41 and the negative electrode 42. In addition, the positive electrode lead 51 may be coupled to the positive electrode 41 on the inner side of the winding of the positive electrode 41 relative to the outermost wind of the positive electrode 41. In such a case, corrosion of the outer package can 10 resulting from creeping up of the electrolytic solution is suppressed. Accordingly, it is possible to achieve further higher reliability.

Further, the sealant 61 may cover the periphery of the positive electrode lead 51, and a portion of the positive electrode lead 51 may be insulated from each of the outer package can 10 and the negative electrode 42 via the sealant 61. In such a case, a short circuit between the positive electrode lead 51 and the outer package can 10 is prevented, and a short circuit between the positive electrode lead 51 and the negative electrode 42 is also prevented. Accordingly, it is possible to achieve higher reliability.

In this case, in particular, covering the periphery of the positive electrode lead 51 with the sealant 61 provides the following effects. When the positive electrode lead 51 is sandwiched by the outer package can 10 and the battery device 40 with the sealant 61 interposed between the positive electrode lead 51 and each of the outer package can 10 and the battery device 40, a grip force is generated between the outer package can 10 and the sealant 61, and also between the battery device 40 and the sealant 61. As a result, it becomes easier for the positive electrode lead 51 to be held by the outer package can 10 and the battery device 40 with the help of the grip force supplied to the positive electrode lead 51 via the sealant 61. As a result, the positive electrode lead 51 is insulated from the outer package can 10 and the negative electrode 42 via the sealant 61. In addition, it becomes further easier for the positive electrode lead 51 to be fixed inside the outer package can 10 with the help of the sealant 61. This makes it possible to achieve further higher physical durability.

Further, the insulating film 62 may be disposed between the outer package can 10 and the positive electrode lead 51, and a portion of the positive electrode lead 51 may be insulated from the outer package can 10 via the insulating film 62. In such a case, a short circuit between the positive electrode lead 51 and the outer package can 10 is prevented. Accordingly, it is possible to achieve higher reliability.

Further, the insulating film 63 may be disposed between the battery device 40 and the positive electrode lead 51, and a portion of the positive electrode lead 51 may be insulated from the negative electrode 42 via the insulating film 63. In such a case, a short circuit between the positive electrode lead 51 and the negative electrode 42 is prevented. Accordingly, it is possible to achieve higher reliability.

Further, the outer package can 10 includes the container part 11 and the cover part 12 that are welded to each other, and the positive electrode lead 51 is turned up once or more, which provides a length margin of the positive electrode lead 51. It thus becomes possible to raise the cover part 12 relative to the container part 11 in the process of manufacturing the secondary battery, particularly in a process of forming the outer package can 10. This allows for easy injection of the electrolytic solution, and furthermore, allows for changing the position of coupling of the positive electrode lead 51 to the positive electrode 41 as desired. Accordingly, it is possible to achieve higher easiness of manufacture.

In this case, the length of the positive electrode lead 51 may be greater than or equal to half the outer diameter D of the outer package can 10. In such a case, it becomes easier to raise the cover part 12 relative to the container part 11 in the process of manufacturing the secondary battery. Accordingly, it is possible to achieve further higher easiness of manufacture.

Further, the secondary battery may have a flat and columnar shape, that is, the secondary battery may be a secondary battery that is referred to as, for example, the coin type or the button type. In such a case, the positive electrode lead 51 is prevented from being easily damaged even in a small-sized secondary battery that is highly constrained in terms of size. Accordingly, it is possible to achieve higher effects in terms of physical durability.

Further, the secondary battery may be a lithium-ion secondary battery. In such a case, it is possible to stably obtain a sufficient battery capacity through the use of insertion and extraction of lithium.

The configuration of the secondary battery described above is appropriately modifiable, including as described below, according to an embodiment. Note that any two or more of the following series of modifications may be combined with each other.

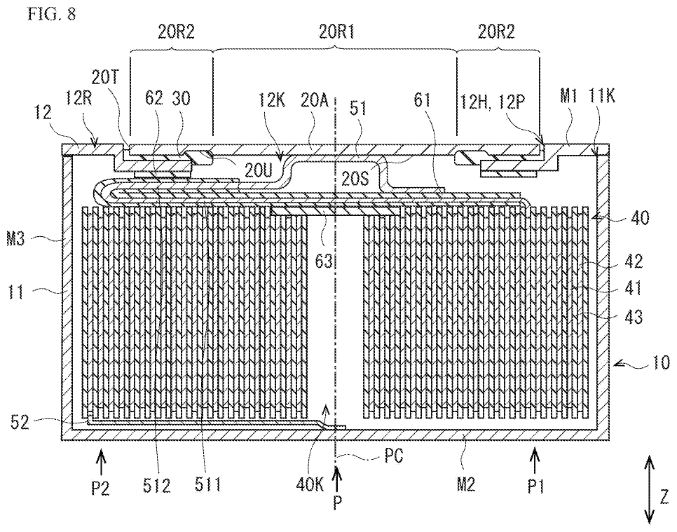

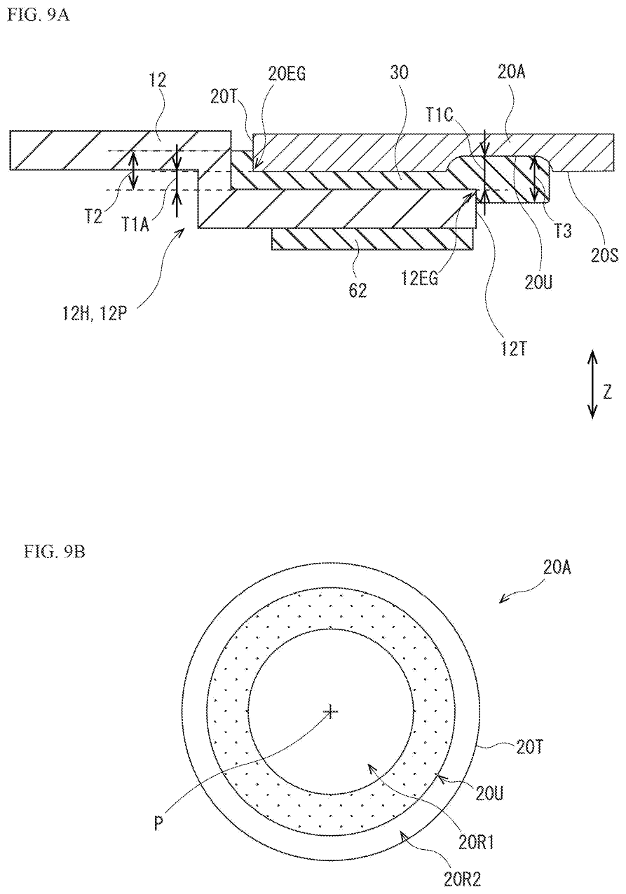

FIG. 2 illustrates an example of the secondary battery including the external terminal 20 in which the opposed surface 20S is entirely a flat surface; however, the technology is not limited thereto. Specifically, the secondary battery of the disclosure may include, instead of the external terminal 20, an external terminal 20A in which a groove 20U is formed in the opposed surface 20S as illustrated in FIG. 8 and FIGS. 9A and 9B. FIG. 8 illustrates a sectional configuration of a secondary battery of an embodiment of the present disclosure. FIG. 9A is a partial enlarged sectional diagram illustrating, in an enlarged manner, a portion of the sectional configuration of the secondary battery illustrated in FIG. 8 in which the external terminal 20A and the cover part 12 are opposed to each other. FIG. 9B is a plan diagram illustrating a planar configuration of the external terminal 20A as viewed in the Z-axis direction from inside the outer package can 10.

The external terminal 20A has the groove 20U provided in the opposed surface 20S opposed to the cover part 12 of the outer package can 10 in the Z-axis direction. The external terminal 20A has a configuration that is substantially the same as the configuration of the external terminal 20 except for having the groove 20U. The groove 20U is provided in the peripheral region 20R2 between the outer peripheral surface 20T of the external terminal 20A and the coupling region 20R1. The groove 20U is provided to surround the coupling region 20R1. Specifically, as illustrated in FIG. 9B, the groove 20U has an annular shape circling around the coupling region 20R1. Note that in the present embodiment, the external terminal 20A is a substantially disk-shaped member and has the outer peripheral surface 20T that is substantially circular in plan shape. The inner peripheral surface 12T of the through hole 12K is located to overlap the groove 20U in the Z-axis direction, or is located to overlap the peripheral region 20R2 in the Z-axis direction. Further, the gasket 30 is provided to fill a portion or all of the groove 20U of the external terminal 20A.

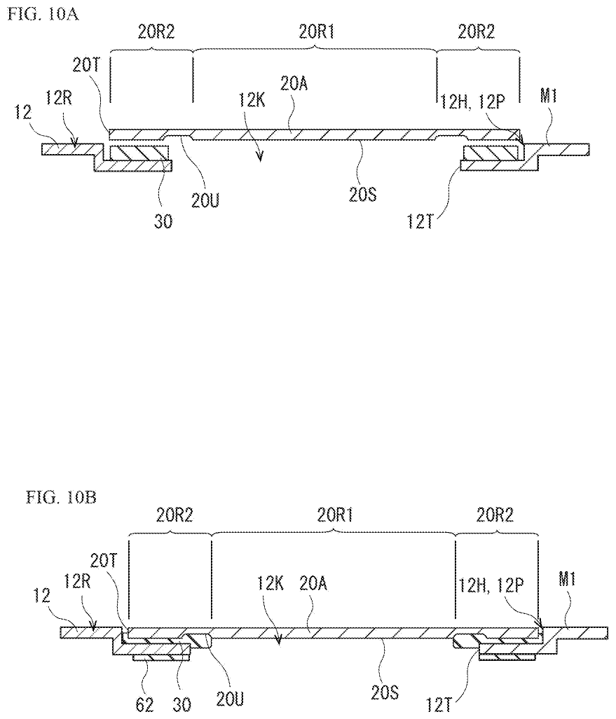

In fabricating the secondary battery, as illustrated in FIG. 10A, for example, the insulating resin 30Z is applied on the surface 12S of the cover part 12, following which the external terminal 20 is further placed on the insulating resin 30Z. Thereafter, as illustrated in FIG. 10B, while the insulating resin 30Z is heated and thereby melted, pressure is applied downward to the external terminal 20 to depress the external terminal 20. As a result, the insulating resin 30Z spreads from the opposed surface 20S to come into contact with also a portion of the outer peripheral surface 20T. At this time, the insulating resin 30Z also spreads toward a center position CP; however, the insulating resin 30Z is received in the groove 20U and is thus prevented from easily reaching the coupling region 20R1. By cooling the insulating resin 30Z in this state, the insulating resin 30Z becomes the gasket 30, which causes the external terminal 20 to be welded to the cover part 12 with the gasket 30 interposed between the external terminal 20 and the cover part 12. Note that each of FIGS. 10A and 10B is an explanatory diagram for describing the process of thermally welding the external terminal 20A to the cover part 12 in the process of manufacturing the secondary battery illustrated in FIG. 8.

As described above, the secondary battery includes the external terminal 20A provided with the groove 20U in the opposed surface 20S. Accordingly, for example, when the insulating resin 30Z to be the gasket 30 is melted by heat to thereby weld the external terminal 20A to the cover part 12 of the outer package can 10, the melted insulating resin 30Z is received in the groove 20U. It is thus possible to limit a region over which the melted insulating resin 30Z spreads. This makes it possible to secure, for example, the coupling region 20R1 of the opposed surface 20S for coupling the positive electrode lead 51, with high dimensional accuracy and sufficiently. Accordingly, it is possible to easily couple the positive electrode lead 51 to the coupling region 20R1 in the process of manufacturing the secondary battery of the present embodiment. This improves easiness of manufacture.

Further, by virtue of the groove 20U allowing for limitation of the region over which the melted insulating resin 30Z spreads, it is possible to reduce variations in thickness of the insulating resin 30Z. This makes it possible to suppress a tilt of the external terminal 20A relative to the cover part 12 caused by unevenness of the spread of the insulating resin 30Z. As a result, it is possible to increase the dimensional accuracy of the secondary battery.

In the secondary battery of the present embodiment, in particular, the groove 20U is provided to surround the coupling region 20R1, that is, to circle around the coupling region 20R1. This makes it possible to secure the plan shape of the coupling region 20R1 with higher accuracy and to further reduce variations in thickness of the insulating resin 30Z surrounding the coupling region 20R1.

Further, in the secondary battery of the present embodiment, the inner peripheral surface 12T of the through hole 12K is located to overlap the groove 20U in the Z-axis direction, or to overlap the peripheral region 20R2 in the Z-axis direction. Accordingly, it is possible to effectively limit a spread region of the gasket 30 extending out of the gap between the opposed surface 20S of the external terminal 20A and the surface 12S of the cover part 12 toward the center position P.

Further, in the secondary battery of the present embodiment, the gasket 30 is provided to fill a portion or all of the groove 20U. This allows the external terminal 20A to be more firmly attached to the cover part 12 with the gasket 30 interposed between the external terminal 20A and the cover part 12.

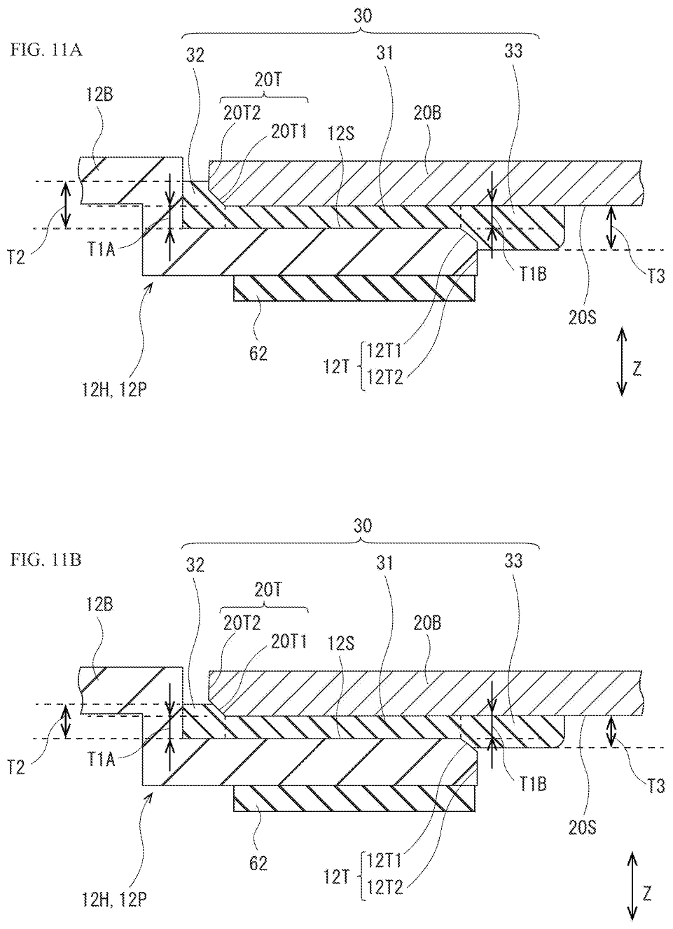

The foregoing embodiment (e.g., FIG. 2) describes an example case in which the outer peripheral surface 20T is substantially orthogonal to the opposed surface 20S; however, the technology is not limited thereto. Specifically, the secondary battery of the present disclosure may include an external terminal 20B instead of the external terminal 20, as does a secondary battery of an embodiment illustrated in each of FIGS. 11A and 11B. Further, the foregoing embodiment (e.g., FIG. 2) describes an example case in which the inner peripheral surface 12T is substantially orthogonal to the surface 12S; however, the technology is not limited thereto. Specifically, the secondary battery of the present disclosure may include a cover part 12B instead of the cover part 12, as does the secondary battery of an embodiment illustrated in each of FIGS. 11A and 11B.

In the external terminal 20B, the outer peripheral surface 20T includes an inclined face 20T1 inclined relative to the opposed surface 20S, and an end face 20T2 substantially orthogonal to the opposed surface 20S. Further, in the cover part 12B, the inner peripheral surface 12T includes an inclined face 12T1 inclined relative to the surface 12S, and an end face 12T2 substantially orthogonal to the surface 12S.

Note that in the secondary battery illustrated in FIG. 11A, the gasket 30 is so formed that the second part 32 is in contact with a region extending from the opposed surface 20S to reach the end face 20T2 through the inclined face 20T1, and that the third part 33 is in contact with a region extending from the opposed surface 20S to reach the end face 12T2 through the inclined face 12T1. In contrast, in the secondary battery illustrated in FIG. 11B, the gasket 30 is so formed that the second part 32 is in contact with a portion of the inclined face 20T1 and that the third part 33 is in contact with a portion of the inclined face 12T1. Even with the secondary battery of FIG. 11B, high airtightness is achieved as compared with a secondary battery in which the gasket 30 is in contact with only the opposed surface 20S and not in contact with any portion of the inclined face 20T1 or any portion of the inclined face 12T1 at all. However, the airtightness inside the outer package can 10 is higher in the secondary battery of FIG. 11A than in the secondary battery of FIG. 11B.

In the example illustrated in each of FIGS. 11A and 11B, the outer peripheral surface 20T of the external terminal 20B includes the inclined face 20T1 and the inner peripheral surface 12T of the cover part 12B includes the inclined face 12T1; however, the disclosure is not limited thereto. The inner peripheral surface 12T may include no inclined face 12T1 when the outer peripheral surface 20T includes the inclined face 20T1. Alternatively, the outer peripheral surface 20T may include no inclined face 20T1 when the inner peripheral surface 12T includes the inclined face 12T1. In either case, according to the disclosure, it is sufficient that the second part 32 continuous with the first part 31 covers at least a portion of the outer peripheral surface 20T. It is also sufficient that the third part 33 continuous with the first part 31 covers at least a portion of the inner peripheral surface 12T. Alternatively, a configuration is possible in which the second part 32 continuous with the first part 31 is in contact with at least a portion of the outer peripheral surface 20T and at the same time, the third part 33 continuous with the first part 31 is in contact with at least a portion of the inner peripheral surface 12T.

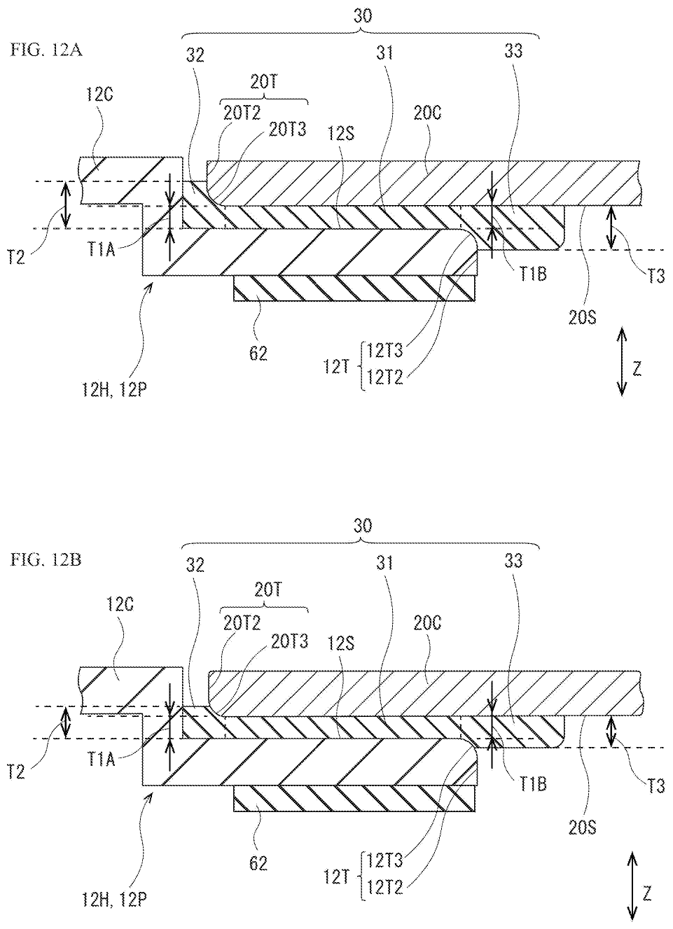

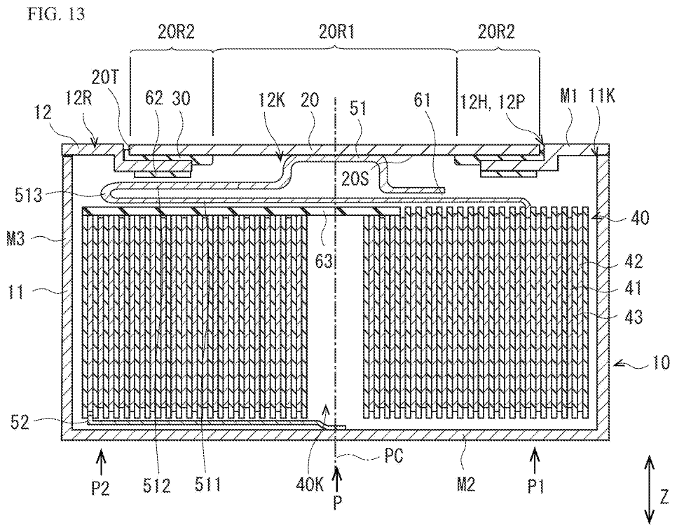

An example case is described herein in which the outer peripheral surface 20T includes a flat surface only; however, the present technology is not limited thereto. For example, the secondary battery of the disclosure may include an external terminal 20C instead of the external terminal 20, as does a secondary battery of an embodiment illustrated in each of FIGS. 12A and 12B. Further, an example case is described herein in which the inner peripheral surface 12T includes a flat surface only; however, the present technology is not limited thereto. For example, the secondary battery of the present disclosure may include a cover part 12C instead of the cover part 12, as does the secondary battery of an embodiment illustrated in each of FIGS. 12A and 12B.

In the external terminal 20C, the outer peripheral surface 20T includes a curved face 20T3 continuous with the opposed surface 20S. Further, in the cover part 12B, the inner peripheral surface 12T includes a curved face 12T3 continuous with the surface 12S. In the secondary battery of Modification 3 also, the thickness T2 is greater than the thickness T1A, and the thickness T3 is greater than the thickness T1B. The thickness T1A is a spacing between the opposed surface 20S and the surface 12S in the Z-axis direction at a position in the opposed surface 20S closest to the curved face 20T3. The thickness T1B is a spacing between the opposed surface 20S and the surface 12S in the Z-axis direction at a position in the opposed surface 20S closest to the curved face 12T3.

Note that in the secondary battery illustrated in FIG. 12A, the gasket 30 is so formed that the second part 32 is in contact with a region extending from the opposed surface 20S to reach the end face 20T2 through the curved face 20T3, and that the third part 33 is in contact with a region extending from the opposed surface 20S to reach the end face 12T2 through the curved face 12T3. In contrast, in the secondary battery illustrated in FIG. 12B, the gasket 30 is so formed that the second part 32 is in contact with a portion of the curved face 20T3 and that the third part 33 is in contact with a portion of the curved face 12T3. Even with the secondary battery of FIG. 12B, high airtightness is achieved as compared with a secondary battery in which the gasket 30 is in contact with only the opposed surface 20S and not in contact with any portion of the curved face 20T3 or any portion of the curved face 12T3 at all. However, the airtightness inside the outer package can 10 is higher in the secondary battery of FIG. 12A than in the secondary battery of FIG. 12B.

In FIG. 2, the secondary battery includes the sealant 61 and the insulating films 62 and 63. However, as long as the positive electrode lead 51 is insulated from each of the outer package can 10 and the negative electrode 42, the secondary battery of the present technology does not necessarily have to include all of the sealant 61 and the insulating films 62 and 63.

For example, the insulating film 63 may be omitted from the secondary battery when the positive electrode lead 51 is insulated from the negative electrode 42 via the separator 43. Secondly, the insulating film 62, the insulating film 63, or both may be omitted from the secondary battery when the positive electrode lead 51 is insulated from each of the outer package can 10 and the negative electrode 42 via the sealant 61. Thirdly, the sealant 61, the insulating film 63, or both may be omitted from the secondary battery when the positive electrode lead 51 is insulated from each of the outer package can 10 and the negative electrode 42 via the separator 43 and the insulating film 62.

Even in such cases, the positive electrode lead 51 is insulated from each of the outer package can 10 and the negative electrode 42, and it is therefore possible to achieve effects similar to the effects achievable with the secondary battery according to the above-described embodiment.

In FIG. 2, the height of the separator 43 is greater than the height of the negative electrode 42, and thus the positive electrode lead 51 is insulated from the negative electrode 42 via the separator 43. However, when a range of placement of the insulating film 63 is extended to allow the positive electrode lead 51 to be insulated from the negative electrode 42 via the insulating film 63, the separator 43 does not have to be adapted to insulate the positive electrode lead 51 from the negative electrode 42.

Even in such a case, the positive electrode lead 51 is insulated from the negative electrode 42 via the insulating film 63, and it is therefore possible to achieve effects similar to the effects achievable with the secondary battery according to the above-described embodiment. However, to prevent precipitation of lithium extracted from the positive electrode 41, the height of the separator 43 is preferably greater than the height of the negative electrode 42.

In the disclosure, a range of the positive electrode lead 51 to be covered by the sealant 61 is not particularly limited, and may be chosen as desired. Specifically, as illustrated in FIG. 13 corresponding to FIG. 2, any of the turning part 513, the second part 512, and a portion of the first part 511, of the positive electrode lead 51 does not necessarily have to be covered by the sealant 61. As illustrated in FIG. 8, a portion of the first part 511 overlapping the second part 512 is not covered by the sealant 61. Note that the electrical insulation between the positive electrode lead 51 and the battery device 40 is achieved by the insulating film 63.

As illustrated in FIG. 13, the overlap portion of the first part 511 and the second part 512 is not covered by the sealant 61. This makes it possible for the overlap portion of the first part 511 and the second part 512 to be smaller in thickness. Further, as illustrated in FIG. 13, the turning part 513 is not covered by the sealant 61, either. This makes it possible for also the turning part 513 to be smaller in thickness. Accordingly, it is possible to further increase a volume occupancy ratio of the battery device 40 inside the outer package can 10. The secondary battery of an embodiment illustrated in FIG. 13 is thus more suited to improvement in energy density per unit volume.

As compared with FIG. 8, the secondary battery of FIG. 2 described in the foregoing embodiment makes it easier for the positive electrode lead 51 to be insulated from the outer package can 10 and the negative electrode 42 via the sealant 61, and accordingly makes it possible to achieve higher reliability.

In FIG. 2, the outer package can 10 is used in which the flat external terminal 20 is attached to an outer side of the cover part 12 including the protruding part 12P (or the recessed part 12H). However, the configuration of the outer package can 10 is not particularly limited, and may be changed as desired. Note that a series of secondary batteries to be described below has a configuration similar to the configuration of the secondary battery illustrated in FIG. 2, except that the configuration of each of the cover part 12 and the external terminal 20 is different.

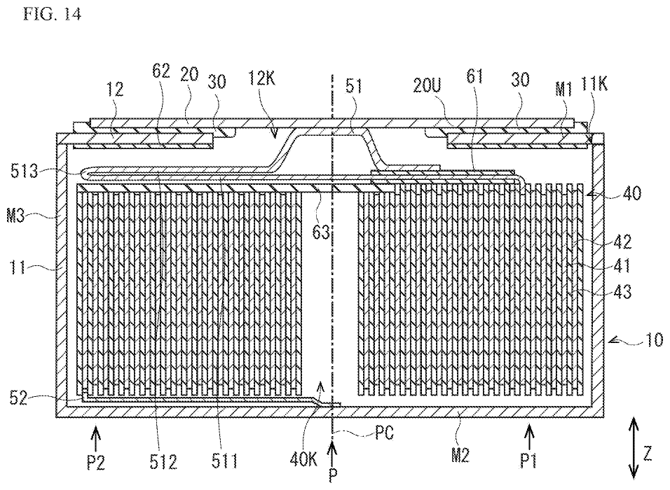

For example, as illustrated in FIG. 14 corresponding to FIG. 2, the outer package can 10 may be used in which the flat external terminal 20 is attached to the outer side of the cover part 12 that is flat and includes no protruding part 12P. In the outer package can 10, the external terminal 20 is attached to the outer side of the cover part 12 having the through hole 12K, with the gasket 30 interposed between the external terminal 20 and the cover part 12.

### EXAMPLES

Examples of the present technology are described below according to an embodiment.

Example secondary batteries o were fabricated, and thereafter, the secondary batteries were evaluated for battery characteristic according to an embodiment. In addition, secondary batteries were fabricated as comparative examples, and thereafter, the comparative example secondary batteries were evaluated for battery characteristic.

### [Fabrication of Secondary Battery]

### Example 1

First, as Example 1, the secondary battery including the external terminal 20B and the cover part 12B illustrated in FIGS. 11A and 11B was fabricated in the following manner.

### (Fabrication of Positive Electrode)

First, 91 parts by mass of the positive electrode active material (LiCoO₂), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into an organic solvent (N-methyl-2-pyrrolidone), following which the organic solvent was stirred to thereby prepare a positive electrode mixture slurry in paste form. Thereafter, the positive electrode mixture slurry was applied on the two opposed surfaces of the positive electrode current collector 41A (a band-shaped aluminum foil having a thickness of 12 μm) by means of a coating apparatus, following which the applied positive electrode mixture slurry was dried to thereby form the positive electrode active material layers 41B. Lastly, the positive electrode active material layers 41B were compression-molded by means of a roll pressing machine. In this manner, the positive electrode 41 having a width of 3.3 mm was fabricated.

### (Fabrication of Negative Electrode)

First, 95 parts by mass of the negative electrode active material (graphite) and 5 parts by mass of the negative electrode binder (polyvinylidene difluoride) were mixed with each other to thereby obtain a negative electrode mixture. Thereafter, the negative electrode mixture was put into an organic solvent (N-methyl-2-pyrrolidone), following which the organic solvent was stirred to thereby prepare a negative electrode mixture slurry in paste form. Thereafter, the positive electrode mixture slurry was applied on the two opposed surfaces of the negative electrode current collector 42A (a band-shaped copper foil having a thickness of 15 μm) by means of a coating apparatus, following which the applied negative electrode mixture slurry was dried to thereby form the negative electrode active material layers 42B. Lastly, the negative electrode active material layers 42B were compression-molded by means of a roll pressing machine. In this manner, the negative electrode 42 having a width of 3.8 mm was fabricated.

### (Preparation of Electrolytic Solution)

The electrolyte salt (LiPF₆) was added to the solvent (ethylene carbonate and diethyl carbonate), following which the solvent was stirred. In this case, a mixture ratio (a weight ratio) between ethylene carbonate and diethyl carbonate in the solvent was set to 30:70, and a content of the electrolyte salt was set to 1 mol/kg with respect to the solvent. The electrolyte salt was thereby dissolved or dispersed in the solvent. Thus, the electrolytic solution was prepared.

### (Assembly of Secondary Battery)

First, the positive electrode lead 51 including aluminum was welded to the positive electrode 41 (the positive electrode current collector 41A) by means of a resistance welding method. The positive electrode lead 51 had a thickness of 0.1 mm, a width of 2.0 mm, and a protruding length of 11.7 mm from the positive electrode 41, and was covered in part at the periphery thereof by the sealant 61 having a tube shape. The sealant 61 was a polypropylene film and had an outer diameter of 9.0 mm and an inner diameter of 3.0 mm. Further, the negative electrode lead 52 including nickel was welded to the negative electrode 42 (the negative electrode current collector 42A) by means of a resistance welding method. The negative electrode lead 52 had a thickness of 0.1 mm, a width of 2.0 mm, and a protruding length of 6.0 mm from the negative electrode 42. In this case, a welding position of the positive electrode lead 51 was adjusted to be in the middle of the winding of the positive electrode 41.

Thereafter, the positive electrode 41 and the negative electrode 42 were stacked on each other with the separator 43 interposed between the positive electrode 41 and the negative electrode 42. The separator 43 was a fine-porous polyethylene film having a thickness of 25 μm and a width of 4.0 mm. Thereafter, the stack of the positive electrode 41, the negative electrode 42, and the separator 43 was wound to thereby fabricate the wound body 40Z having a cylindrical shape with an outer diameter of 11.6 mm. The wound body 40Z had the winding center space 40K having an inner diameter of 2.0 mm.

Thereafter, a ring-shaped underlay insulating film, which was a polyimide film having an outer diameter of 11.6 mm, an inner diameter of 2.2 mm, and a thickness of 0.05 mm, was placed through the opening 11K into the container part 11 having a cylindrical shape. The container part 11 included stainless steel (SUS316) and had a wall thickness of 0.15 mm, an outer diameter of 12.0 mm, and a height of 5.0 mm. Thereafter, the wound body 40Z was placed into the container part 11. In this case, the negative electrode lead 52 was welded to the container part 11 by means of a resistance welding method.

Thereafter, the external terminal 20B including aluminum and having a disk shape was prepared. The external terminal 20B had a wall thickness of 0.3 mm and an outer diameter of 7.2 mm. Further, the cover part 12B including stainless steel (SUS316) and having a disk shape was prepared. The cover part 12B had a wall thickness of 0.15 mm and an outer diameter of 11.7 mm, and had a recessed part 12H provided with a through hole 12K. The recessed part 12H had an inner diameter of 9.0 mm and a step height of 0.3 mm. The through hole 12K had an inner diameter of 3.0 mm. The insulating resin 30Z was applied on the surface 12S of the cover part 12B, following which the external terminal 20 was further placed on the insulating resin 30Z (see FIG. 7A). As the insulating resin 30Z, polyimide was used. Thereafter, while the insulating resin 30Z was heated and thereby melted, pressure was applied downward to the external terminal 20B to depress the external terminal 20B, following which the insulating resin 30Z was cooled. As a result, the external terminal 20B was welded to the cover part 12B by the gasket 30 in a state of having spread from the opposed surface 20S to come into contact with also a portion of the outer peripheral surface 20T and a portion of the inner peripheral surface 12T. At this time, the pressure applied to the external terminal 20B was adjusted to cause the thicknesses T1A, T1B, T2, and T3 of the gasket 30 to be 0.030 mm, 0.030 mm, 0.045 mm, and 0.045 mm, respectively.

Thereafter, by means of a resistance welding method, the positive electrode lead 51 was welded to the coupling region 20R1 of the external terminal 20B attached to the cover part 12B with the gasket 30 interposed between the external terminal 20B and the cover part 12B.

Thereafter, with the cover part 12 being raised relative to the container part 11, the electrolytic solution was injected into the container part 11 through the opening 11K. The wound body 40Z including the positive electrode 41, the negative electrode 42, and the separator 43 was thereby impregnated with the electrolytic solution. Thus, the battery device 40 was fabricated.

Lastly, the opening 11K was closed with the cover part 12B, following which the cover part 12B was welded to the container part 11 by means of a laser welding method. In closing the opening 11K with the cover part 12B, the turning part 513 was formed into a curved shape in a portion of the positive electrode lead 51. Further, the insulating film 62 having a ring shape was disposed between the cover part 12B and the positive electrode lead 51, and the insulating film 63 having a disk shape was disposed between the battery device 40 and the positive electrode lead 51. The insulating film 62 was a polyimide film and had an outer diameter of 9.2 mm and an inner diameter of 3.2 mm. The insulating film 63 was a polyimide film and had an outer diameter of 3.2 mm. In this manner, the outer package can 10 was formed using the container part 11 and the cover part 12B, and the battery device 40 was sealed in the outer package can 10. Thus, the secondary battery was assembled that had an outer diameter of 12.0 mm and a height of 5.0 mm.

### (Stabilization of Secondary Battery)

The secondary battery after being assembled was charged and discharged for one cycle in an ambient temperature environment (at a temperature of 23° C.). Upon the charging, the secondary battery was charged with a constant current of 0.1 C until a voltage reached 4.2 V, and was thereafter charged with a constant voltage of 4.2 V until a current reached 0.05 C. Upon the discharging, the secondary battery was discharged with a constant current of 0.1 C until the voltage reached 3.0 V. Note that 0.1 C was a value of a current that caused the battery capacity (a theoretical capacity) to be completely discharged in 10 hours, and 0.05 C was a value of a current that caused the battery capacity to be completely discharged in 20 hours.

As a result, a film was formed on the surface of, for example, the negative electrode 42, which brought the secondary battery into an electrochemically stable state. Thus, the secondary battery of Example 1 was completed.

### Example 2

Next, a secondary battery of Example 2 was fabricated. Here, an application amount of the insulating resin 30Z was adjusted to cause the thicknesses T1A, T1B, T2, and T3 of the gasket 30 to be 0.030 mm, 0.030 mm, 0.060 mm, and 0.060 mm, respectively. Fabrication conditions of the secondary battery of Example 2 were otherwise similar to the fabrication conditions of the secondary battery of Example 1.

### Example 3

Next, a secondary battery of Example 3 was fabricated. Here, the application amount of the insulating resin 30Z was adjusted to cause the thicknesses T1A, T1B, T2, and T3 of the gasket 30 to be 0.030 mm, 0.030 mm, 0.075 mm, and 0.075 mm, respectively. Fabrication conditions of the secondary battery of Example 3 were otherwise similar to the fabrication conditions of the secondary battery of Example 1.

### Example 4

Next, as Example 4, the secondary battery of the foregoing embodiment including the external terminal 20 and the cover part 12 illustrated in, for example, FIG. 4 was fabricated. Fabrication conditions of the secondary battery of Example 4 were otherwise similar to the fabrication conditions of the secondary battery of Example 1. Here, the application amount of the insulating resin 30Z was adjusted to cause the thicknesses T1A, T1B, T2, and T3 of the gasket 30 to be 0.030 mm, 0.030 mm, 0.045 mm, and 0.045 mm, respectively.

### Comparative Example 1

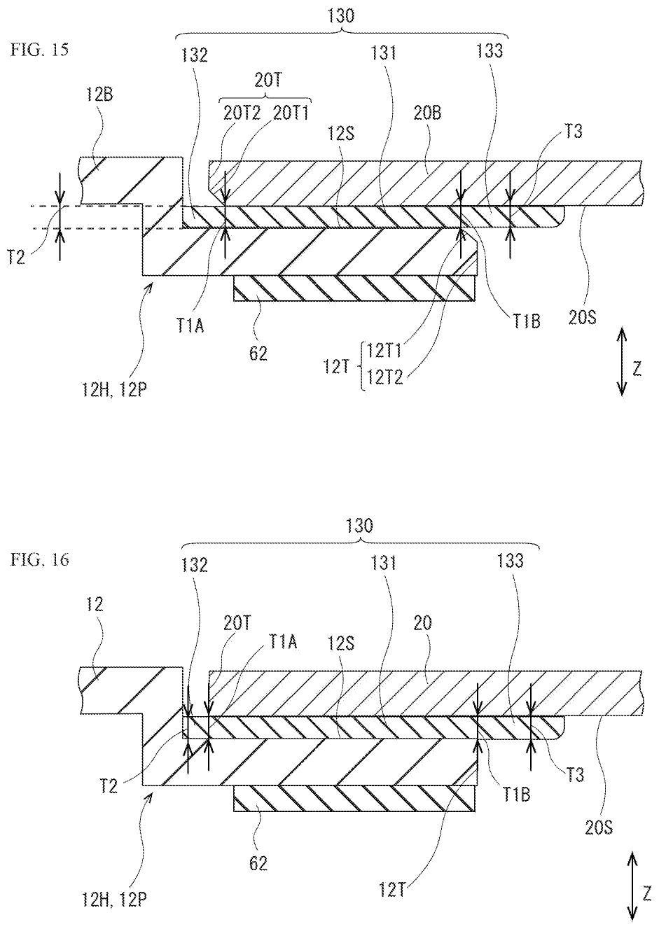

Next, as Comparative example 1, a secondary battery including a gasket 130 illustrated in FIG. 15 was fabricated. The gasket 130 included a first part 131 sandwiched between the surface 12S and the opposed surface 20S, a second part 132 located on a side of the outer peripheral surface 20T and continuous with the first part 131, and a third part 133 located on a side of the inner peripheral surface 12T and continuous with the first part 131. The first part 131 had the thickness T1A and the thickness T1B. The thickness T1A was a thickness of the first part 131 at a position in the opposed surface 20S closest to the inclined face 20T1. The thickness T1B was a thickness of the first part 131 at a position in the opposed surface 20S closest to the inclined face 12T1. Further, the second part 132 had a thickness T2, and the third part 133 had a thickness T3. In Comparative example 1, the application amount of the insulating resin 30Z was adjusted to cause the thicknesses T1A, T1B, T2, and T3 of the gasket 130 to be all 0.030 mm. Fabrication conditions of the secondary battery of Comparative example 1 were otherwise similar to the fabrication conditions of the secondary battery of Example 1.

### Comparative Example 2

Next, as Comparative example 2, a secondary battery including the gasket 130 illustrated in FIG. 16 was fabricated. The gasket 130 included the first part 131 sandwiched between the surface 12S and the opposed surface 20S, the second part 132 located on the side of the outer peripheral surface 20T and continuous with the first part 131, and the third part 133 located on the side of the inner peripheral surface 12T and continuous with the first part 131. The first part 131 had the thickness T1A and the thickness T1B. The thickness T1A was a thickness of the first part 131 at a position in the opposed surface 20S closest to the outer peripheral surface 20T. The thickness T1B was a thickness of the first part 131 at a position in the opposed surface 20S closest to the inner peripheral surface 12T. Further, the second part 132 had the thickness T2, and the third part 133 had the thickness T3. In Comparative example 2, the application amount of the insulating resin 30Z was adjusted to cause the thicknesses T1A, T1B, T2, and T3 of the gasket 130 to be all 0.030 mm. Fabrication conditions of the secondary battery of Comparative example 2 were otherwise similar to the fabrication conditions of the secondary battery of Example 4.

### [Evaluation of Battery Characteristic]

The secondary batteries of Examples 1 to 4 and Comparative examples 1 and 2 described above were each evaluated for cyclability characteristic. The evaluation revealed the results presented in Table 1. Note that Table 1 lists a capacity retention rate serving as an index for evaluating the cyclability characteristic. In addition, Table 1 lists the presence or absence of each of the inclined face 20T1 of the external terminal and the inclined face 12T1 of the cover part, and respective measurements (mm) of the thicknesses T1A, T1B, T2, and T3 of the gasket in the secondary batteries of Examples 1 to 4 and Comparative examples 1 and 2. [Table 1]

TABLE 1

| | Inclined face | | Thickness | Thickness | Thickness | Thickness | Capacity |
|---|---|---|---|---|---|---|---|
| | External | Cover | T1A | T1B | T2 | T3 | retention |
| | terminal | part | [mm] | [mm] | [mm] | [mm] | rate [%] |
| Example 1 | Present | Present | 0.030 | 0.030 | 0.045 | 0.045 | 88 |
| Example 2 | Present | Present | 0.030 | 0.030 | 0.060 | 0.060 | 89 |
| Example 3 | Present | Present | 0.030 | 0.030 | 0.075 | 0.075 | 90 |
| Example 4 | Absent | Absent | 0.030 | 0.030 | 0.045 | 0.045 | 87 |
| Comparative | Present | Present | 0.030 | 0.030 | 0.030 | 0.030 | 84 |
| example 1 | | | | | | | |
| Comparative | Absent | Absent | 0.030 | 0.030 | 0.030 | 0.030 | 84 |
| example 2 | | | | | | | |

The cyclability characteristic was evaluated in the following manner. First, the secondary battery was charged in a high-temperature environment (at a temperature of 50° C.), following which the charged secondary battery was left standing (for a standing time of 3 hours) in the same environment. Upon the charging, the secondary battery was charged with a constant current of 1 C until a voltage reached 4.2 V, and was thereafter charged with a constant voltage of 4.2 V until a current reached 0.05 C. Note that 1 C was a value of a current that caused the battery capacity to be completely discharged in 1 hour.

Thereafter, the secondary battery was discharged in the same environment to thereby measure a discharge capacity (a first-cycle discharge capacity). Upon the discharging, the secondary battery was discharged with a constant current of 3 C until a voltage reached 3.0 V. Note that 3 C was a value of a current that caused the battery capacity to be completely discharged in 10/3 hours.

Thereafter, the secondary battery was repeatedly charged and discharged in the same environment until the number of cycles reached 500 to thereby measure the discharge capacity (a 500th-cycle discharge capacity). Charging and discharging conditions for the second and subsequent cycles were similar to the charging and discharging conditions for the first cycle.

Lastly, the capacity retention rate serving as an index for evaluating the cyclability characteristic was calculated based on the following calculation expression: capacity retention rate (%)=(500th-cycle discharge capacity/first-cycle discharge capacity)×100.

As indicated in Table 1, Comparative examples 1 and 2 both exhibited a capacity retention rate of 84%, whereas Examples 1 to 4 achieved relatively high capacity retention rates in a range from 87% to 90% both inclusive. In view of the results, it is considered that the secondary batteries of Examples 1 to 4 each suppressed volatilization of, for example, the electrolytic solution in the battery device contained in the outer package member, or retarded deterioration of the battery device, for example.

From the results presented in Table 1, it was found that the secondary battery of the present disclosure allowed for increased airtightness inside the outer package member owing to the configuration in which the second part and the third part continuous with the first part were respectively in contact with also at least a portion of the outer peripheral surface of the external terminal and at least a portion of the inner peripheral surface of the through hole of the outer package member. That is, it was confirmed that the secondary battery of the disclosure was able to exhibit stable performance over a long period of time.

Although the present technology has been described above with reference to some embodiments including Examples, the configuration of the present technology is not limited thereto, and is therefore modifiable in a variety of suitable ways.

For example, although the description has been given of the case where the outer package can is a welded can (a crimpless can), the outer package can is not particularly limited in configuration, and may be a crimped can which has undergone crimping processing. In the crimped can, a container part and a cover part separate from each other are crimped to each other with a gasket interposed between the container part and the cover part.

Further, although the description has been given of the case where the battery device has a device structure of a wound type, the device structure of the battery device is not particularly limited, and may be of any other type, such as a stacked type in which the electrodes (the positive electrode and the negative electrode) are stacked, or a zigzag folded type in which the electrodes (the positive electrode and the negative electrode) are folded in a zigzag manner.

Further, although the description has been given of the case where the electrode reactant is lithium, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an outer package member including a surface and a through hole, the through hole extending in a first direction and having an inner peripheral surface intersecting the surface;
a battery device contained in the outer package member;
an external terminal attached to the outer package member to close the through hole and electrically insulated from the outer package member, the external terminal including an opposed surface opposed to the surface of the outer package member in the first direction; and
a sealing part present in a gap between the outer package member and the external terminal, the sealing part including a first part and a third part, the first part being located between the outer package member and the opposed surface of the external terminal and having a first thickness in the first direction, the third part being provided to be in contact with the inner peripheral surface of the outer package member and having a third thickness in the first direction, the third thickness being greater than the first thickness.

2. The secondary battery according to claim 1, wherein
the external terminal further includes an outer peripheral surface intersecting the opposed surface, and
the sealing part further includes a second part provided to be in contact with the outer peripheral surface and having a second thickness in the first direction, the second thickness being greater than the first thickness.

3. The secondary battery according to claim 2, wherein the second part is within a gap between the external terminal and the outer package member.

4. The secondary battery according to claim 2, wherein the third part is continuous with the first part.

5. The secondary battery according to claim 2, wherein the second part is continuous with the first part.

6. The secondary battery according to claim 2, wherein the outer peripheral surface includes an inclined face inclined relative to the opposed surface.

7. The secondary battery according to claim 2, wherein the outer peripheral surface includes a curved face.

8. The secondary battery according to claim 1, wherein the inner peripheral surface includes an inclined face inclined relative to the surface.

9. The secondary battery according to claim 1, wherein the inner peripheral surface includes a curved face.

10. The secondary battery according to claim 1, wherein the external terminal further includes a groove provided in the opposed surface.

11. The secondary battery according to claim 1, wherein the third part has a length in a direction along the external terminal.
